(19) United States
(12) Patent Application Publication
(10) Pub. No.: US 2005/0243713 A1
(43) Pub. Date: Nov. 3, 2005

(54) Node-redundancy control method and node-redundancy control apparatus

(76) Inventor: Masato Okuda, Kawasaki (JP)

Correspondence Address: KATTEN MUCHIN ROSENMAN LLP, 575 MADISON AVENUE, NEW YORK, NY, 10022-2585, US

(21) Appl. No.: 11/158,766

(22) Filed: Jun. 22, 2005

Related U.S. Application Data
(63) Continuation of application No. PCT/JP03/06016, filed on May 14, 2003.

(51) Int. Cl. H04L 12/26; H04J 1/16; G06F 11/00; H04J 3/14; H04L 1/00; H04L 12/56; H04L 12/28; G01R 31/08; G08C 15/00

(52) U.S. Cl. 370/216; 370/242; 370/389

(57) ABSTRACT

A first transmitting unit copies information received from a node, and transmits the information to each of a plurality of nodes of a next-stage group via an active line and at least one backup line. A receiving unit receives the information via the active line and the backup lines, and discards the information received via the backup lines. A second transmitting unit transmits the information received via the active line to a node of a next-stage group. A switching unit switches, when a failure occurs, the active line to one of the backup lines.

### BACKGROUND OF THE INVENTION

1. Field of the Invention

The present invention relates to a node-redundancy control method and a node-redundancy control apparatus for providing redundancy of nodes in a communication network. The invention particularly relates to a node-redundancy control method and a node-redundancy control apparatus capable of decreasing load of traffic at the time of switching a node due to the occurrence of a failure in the node, and capable of switching the load at a high speed.

2. Description of the Related Art

Conventionally, a system called a 1+1 link redundancy system is available as a high-speed circuit redundancy system that is used in mainly a transport device. According to this 1+1 link redundancy system, two nodes are connected to each other using two sets of lines (links), and copied data is transmitted to these two lines.

A node at a receiving side selects a normally active line as an active line and selects the other line as a backup line. This node transfers data from the active line, and discards data from the backup line.

When any failure occurs in the active line, the node at the receiving side selects the normally operating backup line as a new active line, and transfers data from this new active line.

Based on the above redundancy operation, it is possible to avoid a failure that occurs in a line connecting between the two nodes.

However, according to the 1+1 link redundancy system, although a failure in a line (link) can be avoided, when a failure occurs in the node itself, communication cannot be maintained.

In order to solve the above problem, a Virtual Router Redundancy Protocol (VRRP) is conventionally prescribed as a protocol for realizing a node redundancy (see, for example, Japanese Patent Application Laid-open No. 2000-151634).

In the VRRP, two (or more) nodes (IP routes or Ethernet switches) constitute a redundancy group. One node is used to actually transmit and receive frames as an operating node, and other nodes are used as standby nodes when a failure occurs in the operating node.

As explained above, according to the VRRP, for each device that is connected to one node (router), it appears as if the plural nodes (routers) operate as one node (router).

According to the VRRP, among two or more nodes (routers), one node is used as an operating node, and the rest of the nodes (routers) are used as standby nodes. When a failure occurs in the operating node, one of the standby nodes operates as an operating node, thereby avoiding the failure.

In the Ethernet, a protocol called a Spanning Tree Protocol (STP) is conventionally used. By the STP, a logic tree called a Spanning Tree (ST) is created in a network having a loop connection. Data can be transferred along this ST.

When a failure occurs in the ST, other ST that avoids this failure is configured by the STP, thereby avoiding a failure in the line or the node. Because a recalculation of the ST is carried out using the STP, 30 seconds or more time is necessary to restart communication.

As explained above, according to the conventional VRRP and the conventional STP, when a failure occurs in the node or in the link, it becomes possible to recover communication by selecting a backup line.

However, according to the conventional VRRP and the conventional STP, it is necessary to rewrite a transfer table (media-access-control (MAC) address table) in the node at the periphery of the position of the occurrence of a failure.

According to the Ethernet, usually, a transfer table is created by learning an MAC address within a frame. In order to rewrite the transfer table at the time of the occurrence of a failure, it is general to erase the contents of the transfer table and learns the address again, when a failure occurs.

However, when the contents of the transfer table are erased, communication is carried out in a broadcast called a flooding until when the MAC address is learned. Therefore, this becomes a cause of congestion.

As described above, the conventional VRRP and the conventional STP have a problem in that, at the time of switching a node due to the occurrence of a failure in the node, the traffic load increases or the switching takes time, along the rewriting of the transfer table.

### SUMMARY OF THE INVENTION

It is an object of the present invention to at least solve the problems in the conventional technology.

A node-redundancy control method according to one aspect of the present invention, which is for a network system including a node located at each edge of the network and a group of a plurality of nodes, includes first transmitting including copying information received from the node, and transmitting the information to each of the nodes of a next-stage group via an active line and at least one backup line; a receiving including receiving the information via the active line and the backup line, and discarding the information received via the backup line; second transmitting including transmitting the information received via the active line to a nodes of a next-stage group; and switching, when a failure occurs, the active line to one of the backup lines.

A node-redundancy control apparatus according to another aspect of the present invention, which is for a network system including a node located at each edge of the network and a group of a plurality of nodes, includes a first transmitting unit that copies information received from the node, and transmits the information to each of the nodes of a next-stage group via an active line and at least one backup line; a receiving unit that receives the information via the active line and the backup lines, and discards the information received via the backup lines; a second transmitting unit that transmits the information received via the active line to a node of a next-stage group; and a switching unit that switches, when a failure occurs, the active line to one of the backup lines.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of a node-redundancy control apparatus according to a first embodiment of the present invention;

FIG. 2 is a block diagram for explaining a redundancy switching operation according to the first embodiment;

FIG. 3 is a block diagram of a configuration of a node device shown in FIG. 1;

FIG. 4 is a block diagram of a configuration of reception processing units shown in FIGS. 1 and 3;

FIG. 5 is a transfer information table shown in FIG. 4;

FIG. 6 is a switch pair table shown in FIG. 4;

FIG. 7 is a block diagram of a configuration of a switch control unit shown in FIG. 3;

FIG. 8 is a trunk management table shown in FIG. 7;

FIG. 9 is a flowchart for explaining the operation of a transfer port determining unit shown in FIG. 4;

FIG. 10 is a flowchart for explaining the operation of a switch determining unit shown in FIG. 7;

FIGS. 11A and 11B are explanatory diagrams of an operation example according to a second embodiment of the present invention;

FIGS. 12A and 12B are explanatory diagrams of an operation example according to the second embodiment;

FIG. 13 is a flowchart for explaining the operation according to the second embodiment;

FIGS. 14A and 14B are explanatory diagrams of a background of a third embodiment of the present invention;

FIG. 15 is a block diagram of a configuration of a node-redundancy control apparatus according to the third embodiment;

FIG. 16 is a block diagram of a configuration of a switch control unit according to the third embodiment;

FIG. 17 is a redundancy group management table shown in FIG. 16;

FIG. 18 is a flowchart for explaining a failure detection processing according to the third embodiment;

FIG. 19 is a flowchart for explaining a notification message reception processing according to the third embodiment;

FIG. 20 is a flowchart for explaining a response message reception processing according to the third embodiment;

FIG. 21 is a block diagram of a configuration of a node-redundancy control apparatus according to a fourth embodiment of the present invention;

FIG. 22 is a configuration diagram of a transmission processing unit according to the fourth embodiment;

FIG. 23 is a configuration diagram of a reception processing unit according to the fourth embodiment;

FIG. 24 is a configuration diagram of a switch control unit according to the fourth embodiment;

FIG. 25A is a counter node management table shown in FIG. 24;

FIG. 25B is a self node management table shown in FIG. 24;

FIG. 26 is a flowchart for explaining a failure detection processing according to the fourth embodiment;

FIG. 27 is a flowchart for explaining a notification message reception processing according to the fourth embodiment;

FIG. 28 is a block diagram of a configuration of a node-redundancy control apparatus for explaining the operation according to a fifth embodiment of the present invention;

FIG. 29 is a block diagram of the configuration of the node-redundancy control apparatus for explaining the operation according to the fifth embodiment;

FIG. 30 is a block diagram of a configuration of a switch control unit according to the fifth embodiment to a seventh embodiment of the present invention;

FIG. 31 is a block diagram of a configuration of a reception processing unit according to the fifth embodiment;

FIG. 32 is a flowchart for explaining a control command reception processing according to the fifth embodiment;

FIG. 33 is a block diagram of a configuration of a node-redundancy control apparatus for explaining the operation according to a sixth embodiment of the present invention;

FIG. 34 is a block diagram of the configuration of the node-redundancy control apparatus for explaining the operation according to the sixth embodiment;

FIG. 35 is a flowchart for explaining a control command input processing according to the sixth embodiment;

FIG. 36 is a block diagram of a configuration of a node-redundancy control apparatus for explaining the operation according to the seventh embodiment;

FIG. 37 is a block diagram of the configuration of the node-redundancy control apparatus for explaining the operation according to the seventh embodiment;

FIG. 38 is a block diagram of a configuration of a node-redundancy control apparatus for explaining the operation according to an eighth embodiment of the present invention;

FIG. 39 is a block diagram of a configuration of a reception processing unit according to the eighth embodiment;

FIG. 40 is a transfer information table shown in FIG. 39;

FIG. 41 is a switch pair table shown in FIG. 39;

FIG. 42 is a redundancy table shown in FIG. 39;

FIG. 43 is a block diagram of a configuration of a node-redundancy control apparatus according to a ninth and a tenth embodiments of the present invention;

FIG. 44 is a block diagram of a configuration of a reception processing unit according to the ninth embodiment;

FIG. 45 is a transfer information table shown in FIG. 44;

FIG. 46 is a switch node pair table shown in FIG. 44;

FIG. 47 is a switch link pair table shown in FIG. 44;

FIG. 48 is a block diagram of a configuration of a switch control unit according the ninth embodiment;

FIG. 49 is a node-trunk management table shown in FIG. 48;

FIG. 50 is a link-trunk management table shown in FIG. 48;

FIG. 51 is a flowchart for explaining the operation of a transfer port determining unit shown in FIG. 44;

FIG. 52 is a flowchart for explaining the operation of a switch determining unit shown in FIG. 48;

FIG. 53 is a block diagram of a configuration of a reception processing unit according to the tenth embodiment;

FIG. 54 is a switch link pair table shown in FIG. 53;

FIG. 55 is a block diagram of a configuration of a switch control unit according to the tenth embodiment;

FIG. 56 is a link-trunk management table shown in FIG. 55;

FIG. 57 is a flowchart for explaining the operation of a transfer port determining unit shown in FIG. 53;

FIG. 58 is a flowchart for explaining the operation of a switch determining unit shown in FIG. 55;

FIG. 59 is a block diagram of a configuration of a node-redundancy control apparatus for explaining the operation according to an eleventh embodiment of the present invention;

FIG. 60 is a self node management table according to the eleventh embodiment;

FIG. 61 is a counter node management table according to the eleventh embodiment; and

FIG. 62 is a block diagram of a configuration of a modification of the node-redundancy control apparatus according to the first to the eleventh embodiments.

### DETAILED DESCRIPTION OF THE PREFERRED EMBODIMENTS

Exemplary embodiments of a node-redundancy control method and a node-redundancy control apparatus according to the present invention will be explained below in detail with reference to the accompanying drawings.

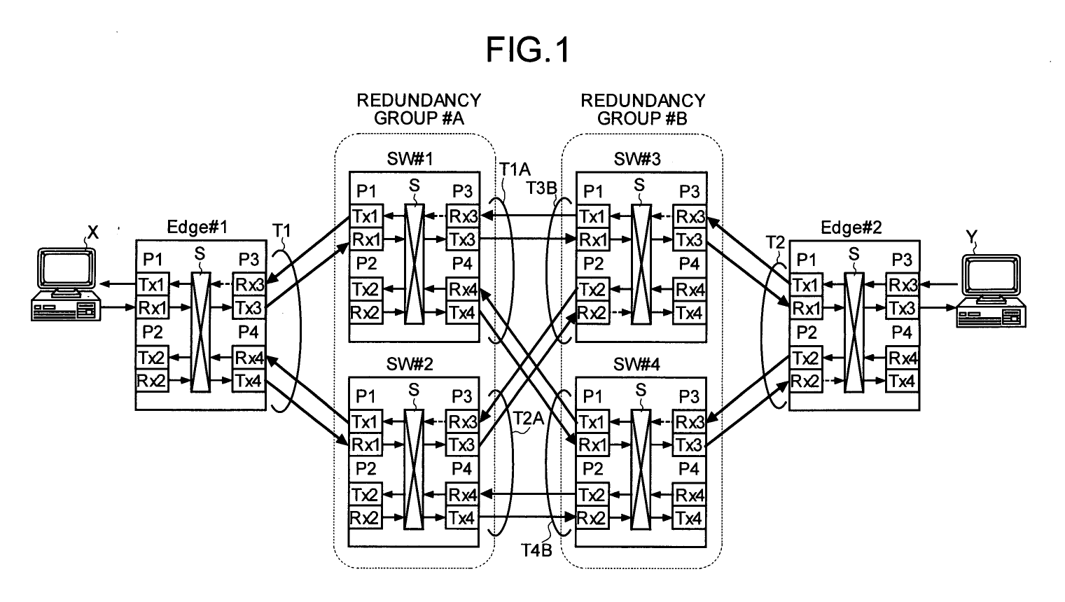

FIG. 1 is a block diagram of a configuration of a node-redundancy control apparatus according to a first embodiment of the present invention. In FIG. 1, there is shown a communication network system including two node devices of Edge#1 and Edge#2, and four node devices SW#1 to SW#4, for carrying out communications between a terminal X and a terminal Y.

The terminals X and Y are computer terminals having a communication function respectively, and carry out communication between the terminals via the communication network system following a predetermined communication protocol. The node device Edge#1 and the node device Edge#2 have a function of an edge node respectively, and are connected to the terminals X and Y respectively.

On the other hand, the node devices SW#1 to SW#4 are provided between the node device Edge#1 and the node device Edge#2, and have a function of a core node respectively. In the node devices SW#1 to SW#4, the node device SW#1 and the node device SW#2 constitute a redundancy group #A, and the node device SW#3 and the node device SW#4 constitute a redundancy group #B. In the first embodiment, each redundancy group can include two or more node devices.

Each of the node device Edge#1, the node device Edge#2, and the node devices SW#1 to SW#4 has ports P1 to P4, a switch S, and a switch control unit (not shown).

Each port P1 has a transmission processing unit Tx1 and a reception processing unit Rx1. Each port P2 has a transmission processing unit Tx2 and a reception processing unit Rx2. Each port P3 has a transmission processing unit Tx3 and a reception processing unit Rx3. Each port P4 has a transmission processing unit Tx4 and a reception processing unit Rx4.

The port P1 of the node device Edge#1 is connected to the terminal X via a line. In the node device Edge#1, the port P3 is connected to the port P1 of the node device SW#1 via a line, and the port P4 is connected to the port P1 of the node device SW#2 via a line.

In the node device Edge#1, plural physical lines (the line of the port P3 and the line of the port P4) are recognized as a trunk (line) T1 as one logical line.

In the node device SW#1, the port P1 is connected to the port P3 of the node device Edge#1 via the line of the port P1. However, the line of the port P1 is not recognized as a trunk. Similarly, in the node device SW#2, the port P1 is connected to the port P4 of the node device Edge#1 via the line of the port P1. However, the line of the port P1 is not recognized as a trunk.

Regarding the connection between the redundancy group #A and the redundancy group #B, two sets of node devices that constitute each redundancy group are mutually connected.

Specifically, in the node device SW#1, the port P3 is connected to the port P1 of the node device SW#3 via the line, and the port P4 is connected to the port P1 of the node device SW#4 via the line.

On the other hand, in the node device SW#2, the port P3 is connected to the port P2 of the node device SW#3 via the line, and the port P4 is connected to the port P2 of the node device SW#4 via the line.

In the node device SW#1, plural physical lines (the line of the port P3 and the line of the port P4) are recognized as a trunk (line) T1A as one logical line.

In the node device SW#2, plural physical lines (the line of the port P3 and the line of the port P4) are recognized as a trunk (line) T2A as one logical line.

In the node device SW#3, plural physical lines (the line of the port P1 and the line of the port P2) are recognized as a trunk (line) T3B as one logical line.

In the node device SW#4, plural physical lines (the line of the port P1 and the line of the port P2) are recognized as a trunk (line) T4B as one logical line.

The port P3 of the node device Edge#2 is connected to the terminal Y via a line. In the node device Edge#2, the port P1 is connected to the port P3 of the node device SW#3 via a line, and the port P2 is connected to the port P3 of the node device SW#4 via a line.

In the node device Edge#2, plural physical lines (the line of the port P1 and the line of the port P2) are recognized as a trunk (line) T2 as one logical line.

In the node device SW#3, the port P3 is connected to the port P1 of the node device Edge#2 via the line of the port P3. However, the line of the port P3 is not recognized as a trunk. Similarly, in the node device SW#4, the port P3 is connected to the port P2 of the node device Edge#2 via the line of the port P3. However, the line of the port P3 is not recognized as a trunk.

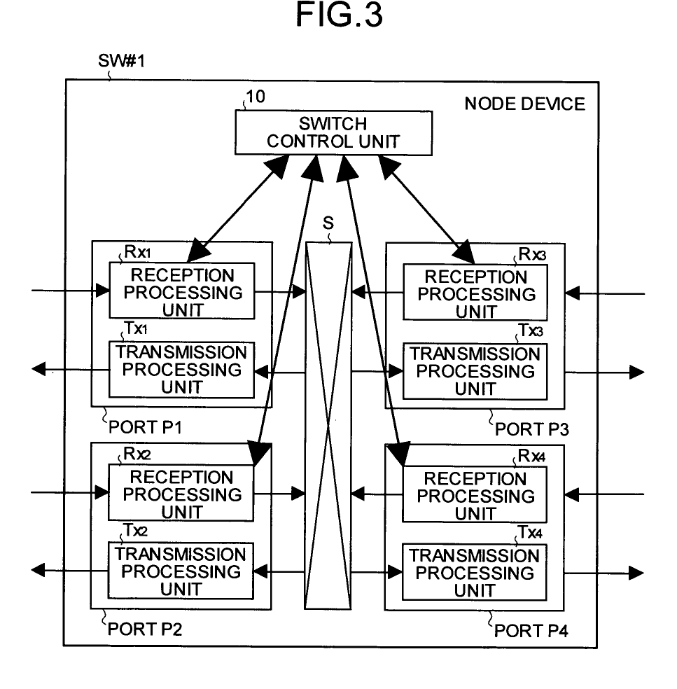

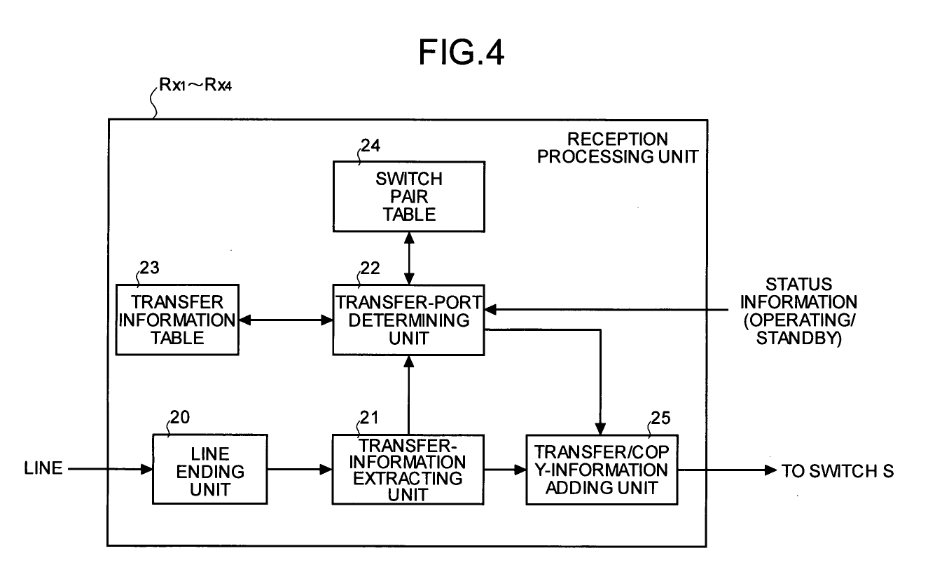

FIG. 3 is a block diagram of a configuration of the node device SW#1 shown in FIG. 1. In FIG. 3, like parts corresponding to those in FIG. 1 are designated with like referencesigns. In FIG. 3, a switch control unit 10 controls the ports P1 to P4, and notifies status information (operating/standby) shown in FIG. 4 to the reception processing units Rx1 to Rx4, for example. The status information expresses a status as to whether a line connected to each port is an active line or a backup line.

FIG. 4 is a block diagram of a configuration of the reception processing units Rx1 to Rx4 shown in FIGS. 1 and 3. In FIG. 4, a line terminating unit 20 has a function of terminating an electrical signal or an optical signal from a line. A transfer information extracting unit 21 extracts transfer information (a destination MAC address, a VLAN-ID, etc.) that expresses a transfer destination from a header of a received frame.

A transfer port determining unit 22 has a function of determining a port as a transfer destination of a received frame, based on the status information (operating/standby) from the switch control unit 10 (see FIG. 3) and the transfer information (in this case, a MAC address of a destination. In the case of an IP router, an IP address of a destination. In the case of MPLS, Label) extracted by the transfer information extracting unit 21.

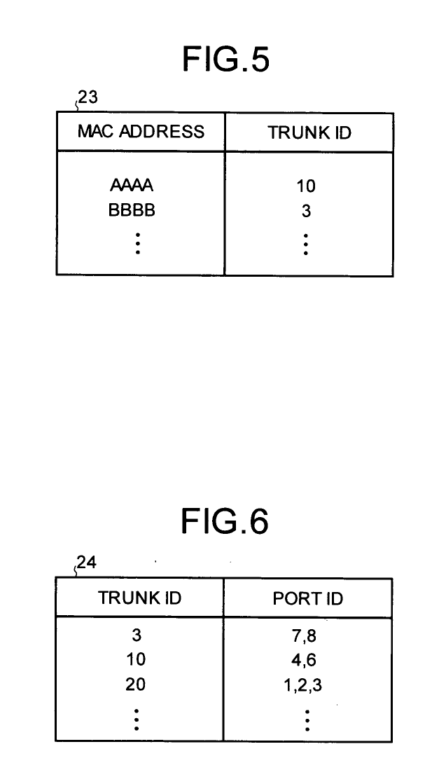

A transfer information table 23 expresses a relationship between an MAC address and a trunk ID (including a port ID) as shown in FIG. 5. The MAC address is transfer information extracted by the transfer information extracting unit 21. The trunk ID is an identifier that identifies a trunk set of the node device. The port ID is an identifier that identifies a port.

When a trunk ID=10 shown in FIG. 5 corresponds to the trunk T1A of the node device SW#1 shown in FIG. 1, for example, a frame (corresponding to an MAC address=AAAA) received by the reception processing unit Rx1 of the port P1 is transferred to the trunk T1A (the ports P3 and P4) of the trunk ID=10 based on the transfer information table 23 (see FIG. 5).

Referring back to FIG. 4, a switch pair table 24 expresses which line (port) constitutes a trunk. Specifically, the switch pair table 24 expresses a relationship between a trunk ID and a port ID (line) as shown in FIG. 6. The trunk ID is an identifier that identifies a trunk set of the node device. The port ID is an identifier that identifies a port corresponding to plural lines that constitute the trunk.

When the trunk ID=10 corresponds to the trunk T1A of the node device SW#1 shown in FIG. 1, for example, the port ID (=4, 6) corresponds to the port P3 and the port P4 respectively that correspond to the lines constituting the trunk T1A. Plural trunk IDs are set in the switch pair table 24. This indicates that plural trunks are set in each node device.

A transfer/copy information adding unit 25 adds a tag indicating a port as to which a frame is to be transferred, to a frame based on a determination made by the transfer port determining unit 22, and outputs this information to a switch S.

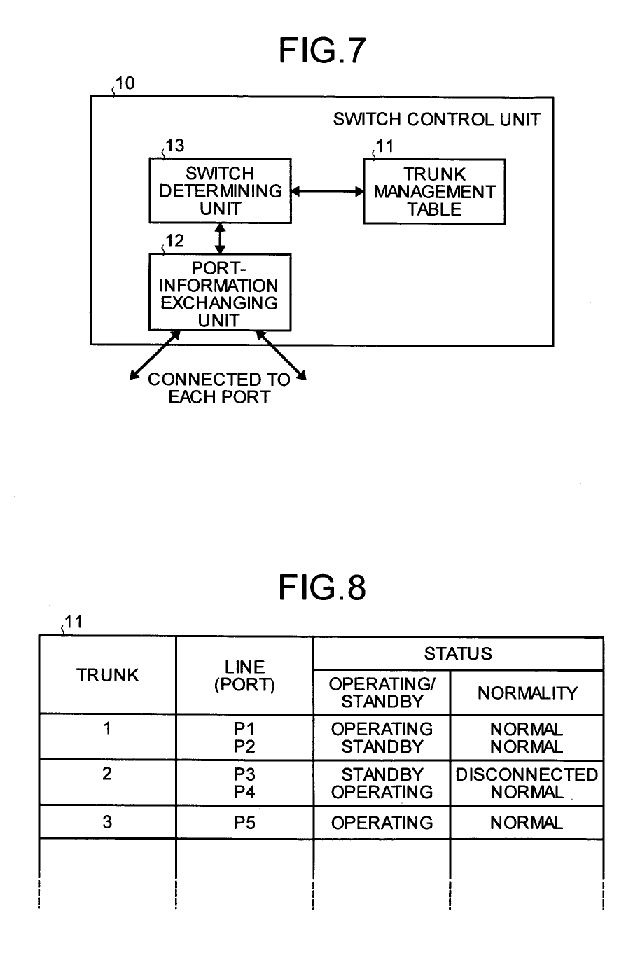

FIG. 7 is a block diagram of a configuration of the switch control unit 10 shown in FIG. 3. In FIG. 7, a trunk management table 11 is used to manage a trunk of each node device. Specifically, the trunk management table 11 expresses a relationship between a trunk, a line, and a status as shown in FIG. 8.

In FIG. 8, the trunk expresses a trunk that is set in each node device. The line (port) expresses a line (port) that constitutes the trunk. The status expresses operating/standby and normality. The operating/standby expresses whether the line (port) is an active line or a backup line. The normality expresses whether the line (port) is normal or is disconnected due to the occurrence of a failure.

For example, in FIG. 1, the port P4 (line) of the node device Edge#1, the port P3 (line) of the node device SW#1, the port P4 (line) of the node device SW#2, the port P1 (line) of the node device SW#3, the port P2 (line) of the node device SW#4, and the port P1 (line) of the node device Edge#2 are set in the active lines respectively.

On the other hand, the port P3 (line) of the node device Edge#1, the port P4 (line) of the node device SW#1, the port P3 (line) of the node device SW#2, the port P2 (line) of the node device SW#3, the port P1 (line) of the node device SW#4, and the port P2 (line) of the node device Edge#2 are set in the backup lines respectively.

A port information exchanging unit 12 exchanges information with the ports P1 to P4 (see FIG. 3). When a switch determining unit 13 receives a notice of a failure to the effect that a line failure occurs from a certain port via the port information exchanging unit 12, for example, the switch determining unit 13 determines about a switching based on the line in which the failure occurs and the trunk management table 11 (see FIG. 8), and notifies a result of the determination to the relevant port.

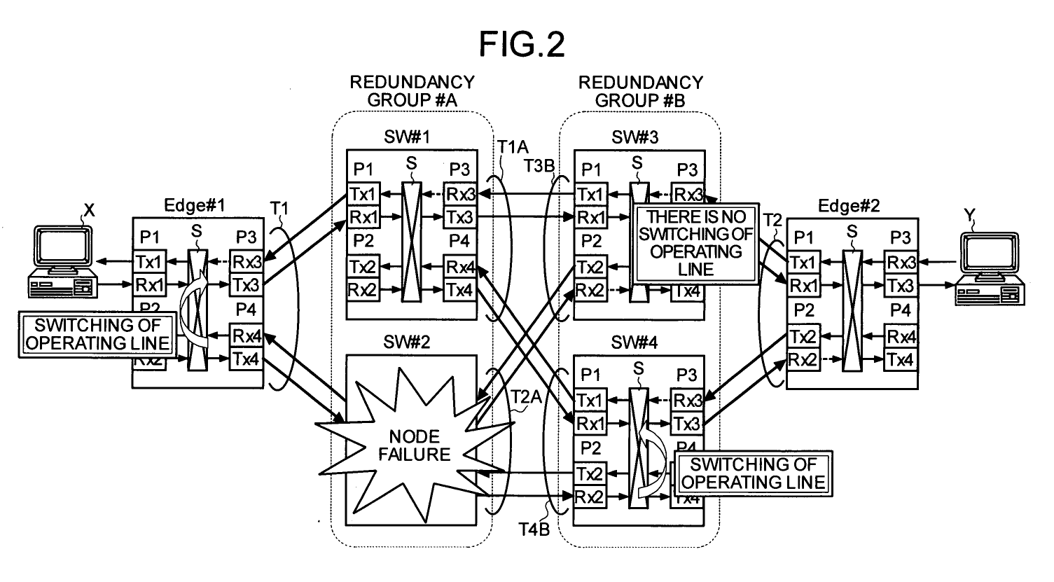

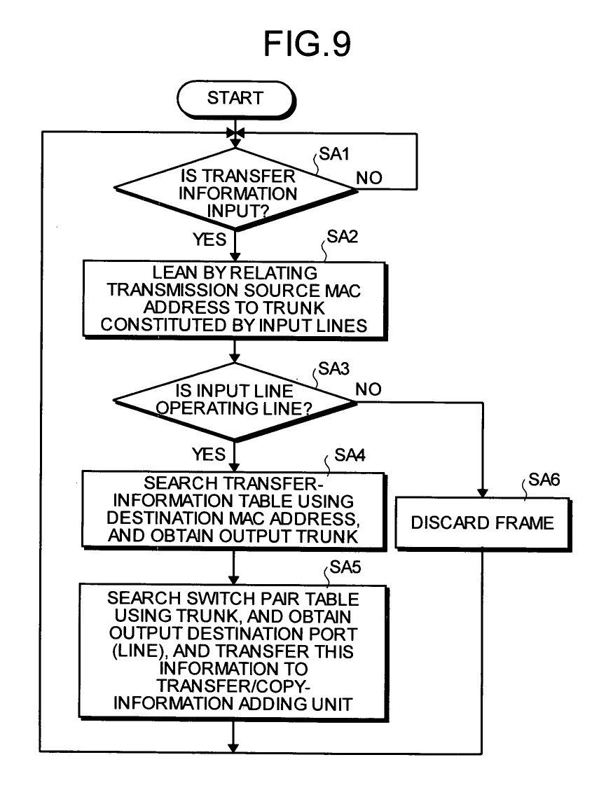

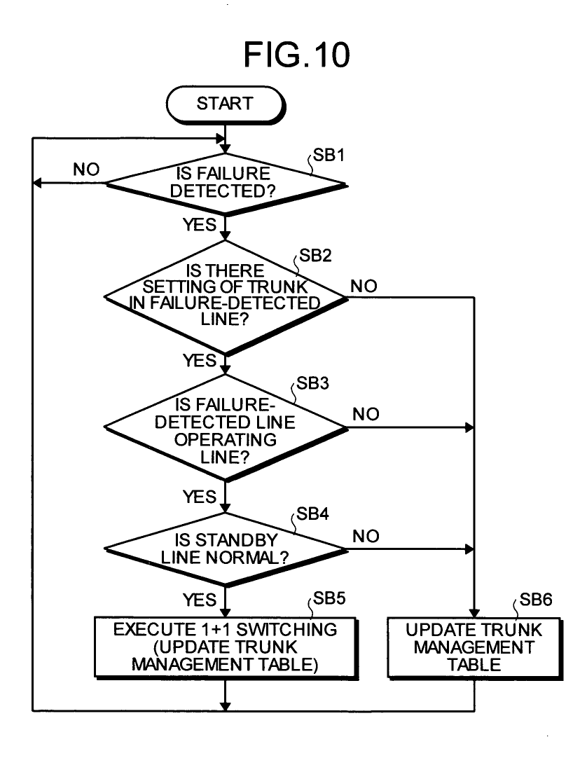

The operation of the node-redundancy control apparatus according to the first embodiment is explained next with reference to FIG. 1, FIG. 2, and flowcharts shown in FIGS. 9 and 10. FIG. 2 is a block diagram for explaining the redundancy switching operation according to the first embodiment. FIG. 9 is a flowchart for explaining the operation of the transfer port determining unit 22 shown in FIG. 4. FIG. 10 is a flowchart for explaining the operation of the switch determining unit 13 shown in FIG. 7.

The operation of transmitting a frame from the terminal X to the terminal Y shown in FIG. 1 is explained below. At step SA1 shown in FIG. 9, the transfer port determining unit 22 (see FIG. 4) of each reception processing unit determines whether transfer information (frame) is input. In this case, the transfer port determining unit 22 sets “No” as the result of the determination made, and repeats the determination.

At step SB1 shown in FIG. 10, the switch determining unit 13 (see FIG. 7) determines whether a failure is detected in the port. In this case, the switch determining unit 13 sets “No” as the result of the determination made, and repeats the determination.

When a frame is transmitted from the terminal X shown in FIG. 1 to the terminal Y, the reception processing unit Rx1 of the node device Edge#1 receives this frame.

In other words, the line terminating terminal 20 ends the electrical signal or the optical signal corresponding to the frame. The transfer information extracting unit 21 extracts transfer information (in this case, a destination MAC address corresponding to the terminal Y) that expresses a transfer destination from the header of the received frame, and outputs the extracted transfer information to the transfer port determining unit 22 and the transfer/copy information adding unit 25.

The transfer port determining unit 22 sets “Yes” as the result of the determination made at step SA1 shown in FIG. 9. At step SA2, the transfer port determining unit 22 learns by relating a transmission source MAC address to the trunk (port) that constitutes the input line.

At step SA3, the transfer port determining unit 22 determines whether the input line (the line corresponding to the port P1) is an active line based on the status information (in this case, the active line) from the switch control unit 10 (see FIG. 3). In this case, the transfer port determining unit 22 sets “Yes” as the result of the determination made.

At step SA4, the transfer port determining unit 22 searches the transfer information table 23 using the transfer information (the destination MAC address) from the transfer information extracting unit 21 as a key, and obtains information of an output trunk (in this case, the trunk T1).

At step SA5, the transfer port determining unit 22 searches the switch pair table 24 using the output trunk (in this case, the trunk T1) as a key, and obtains information of the output destination ports (lines).

In this case, the output destination ports (lines) are the port P3 and the port P4 corresponding to the trunk T1. The transfer port determining unit 22 transfers the information of the output destination ports (lines) corresponding to the port P3 and the port P4 to the transfer/copy information adding unit 25, and determines at step SA1.

The transfer/copy information adding unit 25 adds tags corresponding to the port P3 and the port P4 to the frames from the transfer information extracting unit 21, and outputs the frames to the switch S.

The switch S refers to the tags and copies the frames, and transfers each frame to the port P3 (the transmission processing unit Tx3) and the port P4 (the transmission processing unit Tx4) of the node device Edge#1.

In the node device Edge#1, the port P3 (the transmission processing unit Tx3) transmits the frame to the port P1 (the reception processing unit Rx1) of the node device SW#1, and the port P4 (the transmission processing unit Tx4) transmits the frame to the port P1 (the reception processing unit Rx1) of the node device SW#2.

When the port P1 (the reception processing unit Rx1) of the node device SW#1 receives the frame, the switch S copies the frame in a similar manner to that of the operation carried out by the node device Edge#1.

In the node device Edge#1, the port P3 (the transmission processing unit Tx3) transmits the frame to the port P1 (the reception processing unit Rx1) of the node device SW#1, and the port P4 (the transmission processing unit Tx4) transmits the frame to the port P1 (the reception processing unit Rx1) of the node device SW#2.

When the port P1 (the reception processing unit Rx1) of the node device SW#2 receives the frame, the switch S copies the frame in a similar manner to that of the operation carried out by the node device SW#l.

In the node device SW#2, the port P3 (the transmission processing unit Tx3) transmits the frame to the port P2 (the reception processing unit Rx2) of the node device SW#3, and the port P4 (the transmission processing unit Tx4) transmits the frame to the port P2 (the reception processing unit Rx2) of the node device SW#4.

When the port P1 (the reception processing unit Rx1: the active line) of the node device SW#3 receives the frame, the frame is transmitted from the port P3 (the transmission processing unit Tx3) to the port P1 of the node device Edge#2 via the switch S, in a similar manner to that of the above operation.

When the port P2 (the reception processing unit Rx2: the backup line) of the node device SW#3 receives the frame, through the above operation, the transfer information extracting unit 21 of the reception processing unit Rx2 sets a result of the determination made at step SA1 shown in FIG. 9 to “Yes”. At step SA2, the transfer port determining unit 22 learns by relating the transmission source MAC address to the trunk (port) that constitutes the input line.

At step SA3, the transfer port determining unit 22 determines whether the input line (the line corresponding to the port P2) is an active line based on the status information (in this case, the backup line) from the switch control unit 10 (see FIG. 3). In this case, the transfer port determining unit 22 sets “No” as the result of the determination made.

At step SA6, the transfer port determining unit 22 makes the transfer/copy information adding unit 25 to discard the frame, and determines at step SA1. In other words, in the node device SW#3, out of the two lines (the port P1 and the port P2) at the receiving side, the frame received by using one line as an active line is transmitted, and the frame received by using the other line as a backup line is discarded.

Similarly, in the node device SW#4, out of the two lines (the port P1 and the port P2) at the receiving side, the frame received by using the line at the port P1 as an active line is transferred from the port P3 (the transmission processing unit Tx3) to the port P2 (the reception processing unit Rx2) of the node device Edge#2. The frame received by using the line at the port P1 as a backup line is discarded.

When the port P1 (the reception processing unit Rx1: the active line) of the node device Edge#2 receives the frame, the frame is transmitted from the port P3 (the transmission processing unit Tx3) to the terminal Y via the switch S, in a similar manner to that of the above operation.

On the other hand, when the port P2 (the reception processing unit Rx2: the backup line) of the node device Edge#2 receives a frame, the frame is discarded in a similar manner to that of the above operation.

The above explains the operation carried out when the network is normally operating. The operation when a failure (a node failure) occurs in the node device itself that constitutes a redundancy group is explained next with reference to FIG. 2.

In FIG. 2, when a node failure occurs in the node device SW#2 that constitutes the redundancy group #A, this failure affects the node device Edge#1, the node device SW#3, and the node device SW#4 of which trunks are connected to the node device SW#2. This failure has a potential of the need of switching.

Specifically, among the node device Edge#1, the node device SW#3, and the node device SW#4, the lines (the port P4, the port P2) of the node device Edge#1 and the node device SW#4 that are connected to the node device SW#2 are the active lines. Therefore, this failure causes a disconnection of the communication. Consequently, the active line needs to be switched from the failure-detected line (the active line when the failure occurs) to the backup line.

In other words, when a node failure occurs in the node device SW#2, the port P4 (the reception processing unit Rx4) of the node device Edge#1 cannot receive a predetermined signal or light. Therefore, the node device Edge#1 detects the node failure, and notifies the failure to the switch control unit 10 (FIGS. 3 and 7).

As a result, the switch determining unit 13 of the switch control unit 10 sets “Yes” as the result of the determination made at step SB1 shown in FIG. 10. At step SB2, the switch determining unit 13 refers to the trunk management table 11 (see FIG. 8), and determines whether there is a setting of a trunk to the failure-detected line (in this case, the line of the port P4 of the node device Edge#1). The switch determining unit 13 sets “Yes” as the result of the determination made.

When a result of the determination made at step SB2 is “No”, the switch determining unit 13 updates, at step SB6, the trunk management table 11 regarding the failure-detected line (the normality is changed from normal to disconnected).

At step SB3, the switch determining unit 13 refers to the trunk management table 11, and determines whether the failure-detected line is an active line. In this case, the switch determining unit 13 sets “Yes” as the result of the determination made. When a result of the determination made at step SB3 is “No”, the processing at step SB6 is executed.

At step SB4, the switch determining unit 13 refers to the trunk management table 11, and determines whether the backup line (in this case, the line of the port P3 of the node device Edge#1) corresponding to the current active line (in this case, the line of the port P4 of the node device Edge#1) is normal. In this case, the switch determining unit 13 sets “Yes” as the result of the determination made. When a result of the determination made at step SB4 is “No”, the processing at step SB6 is executed.

At step SB5, the switch determining unit 13 executes the 1+1 switching to switch the active line from the failure-detected line to the backup line. Specifically, the switch determining unit 13 notifies status information (the backup line) to the port P4 (the reception processing unit Rx4 and the transmission processing unit Tx4) as the failure-detected line, and notifies status information (the active line) to the port P3 (the reception processing unit Rx3 and the transmission processing unit Tx3) as the backup line. The switch determining unit 13 updates the trunk management table 11.

As a result, in the node device Edge#1, the line of the port P3 is switched from the backup line to the active line, and the line of the port P4 is switched from the active line to the backup line.

Similarly, in the node device SW#4, the line of the port P2 is switched from the active line to the backup line, and the line of the port P1 is switched from the backup line to the active line, like in the node device Edge#1.

On the other hand, in the node device SW#3, because the failure-detected line (the line of the port P2) is a backup line, a result of the determination made at step SB3 shown in. FIG. 10 is set to “No”, and only the trunk management table 11 is updated. The switching of the active line is not executed. In other words, even when a node failure occurs in the node device SW#2, a line disconnection does not occur in the node device SW#3.

As explained above, according to the first embodiment, the same frame is received via the active line and the backup line. The frame received via the backup line is discarded. The frame received via the active line is transmitted to the next node device. When a failure occurs on the active line or the node device originating the active line, the active line is switched to the backup line. Therefore, the traffic load at the time of switching due to the node failure can be decreased, and the line can be switched in a very short period.

According to the first embodiment, an operation that is carried out when a failure occurs in the line (link) that does not constitute a trunk, and another operation that is carried out when a failure occurs in all lines that constitute one trunk at the same time have not been explained. In this case, the failure can be notified to a node device that is connected to the line in which the failure occurs. An example of this configuration is explained below as a second embodiment of the present invention.

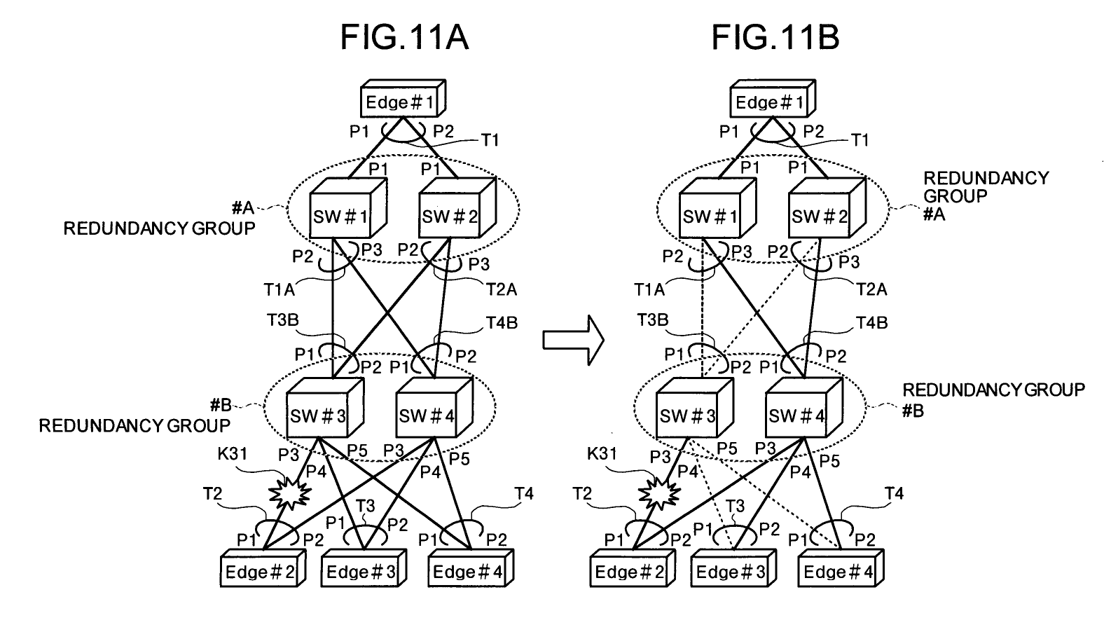

FIGS. 11A and 11B are explanatory diagrams of an operation example 1 according to the second embodiment. A communication network system shown in FIG. 11A includes the node device Edge#1, the redundancy group #A (the node device SW#1 and the node device SW#2), the redundancy group #B (the node device SW#3 and the node device SW#4), the node device Edge#2, a node device Edge#3, and a node device Edge#4.

In the node device Edge#1, the trunk T1 includes the port P1 (for example, an active line), and the port P2 (for example, a backup line).

In the node device SW#1, the trunk T1A includes the port P2 and the port P3. The port P1 of the node device SW#1 does not constitute a trunk.

In the node device SW#2, a trunk T2A includes the port P2 and the port P3. The port P1 of the node device SW#2 does not constitute a trunk.

In the node device SW#3, a trunk T3B includes the port P1 and the port P2. Each of the port P3, the port P4, and a port P5 of the node device SW#3 does not constitute a trunk.

In the node device SW#4, a trunk T4B includes the port P1 and the port P2. Each of the port P3, the port P4, and the port P5 of the node device SW#3 does not constitute a trunk.

In the node device Edge#2, a trunk T2 includes the port P1 and the port P2. In the node device Edge#3, a trunk T3 includes the port P1 and the port P2. In the node device Edge#4, a trunk T4 includes the port P1 and the port P2. Each of the ports P1 to P4 includes a reception processing unit and a transmission processing unit, like in the first embodiment.

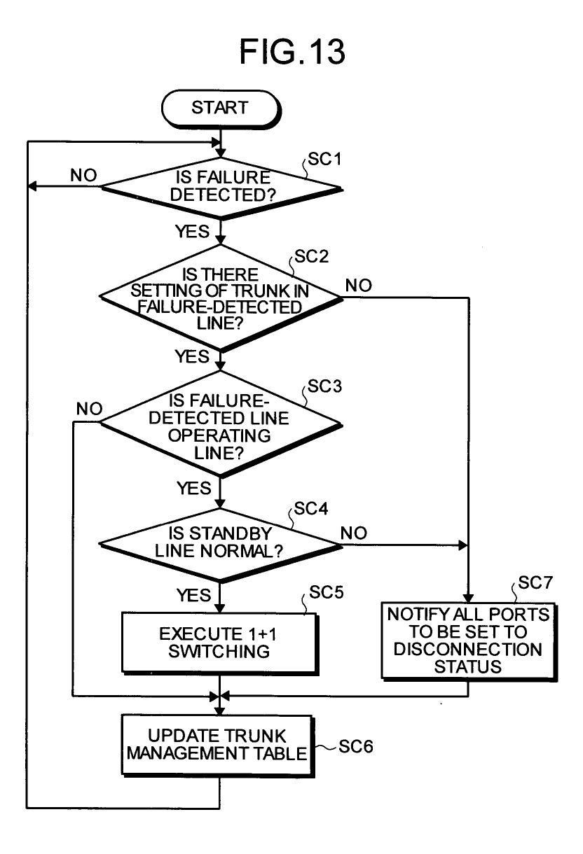

The operation example 1 according to the second embodiment is explained below with reference to FIG. 11A, FIG. 11B, and a flowchart shown in FIG. 13. In the operation example 1, the operation carried out when a failure occurs in a line K31 (see FIG. 11B) that does not constitute a trunk is explained.

At step SC1 shown in FIG. 13, each node device determines whether a failure occurs in the line connected. In this case, each node device sets “No” as the result of the determination made, and repeats the same determination. When a failure (a line disconnection) occurs in the line K31 shown in FIG. 11, the node device Edge#2 switches the active line from the port P1 (the failure-detected line) to the port P2 (the backup line), in a similar manner to that according to the first embodiment.

When the failure occurs in the line K31, the node device Edge#3 and the node device Edge#4 cannot communicate with the node device Edge#2 via the node device SW#3 and the line K31.

In the operation example 1 according to the second embodiment, the node device SW#3 notifies all ports (in this case, the port P4 and the port P5) which are under the influence of the line K31 to disconnect the line. Accordingly, the node device Edge#3 and the node device Edge#4 recognize the lines in all the ports are in the disconnection status (a failure occurrence).

Specifically, upon detecting the failure in the line K31, the node device SW#3 sets “Yes” as the result of the determination made at step SC1 shown in FIG. 13. At step SC2, the node device SW#3 determines whether there is a setting of a trunk in the failure-detected line (in this case, the line K31 of the port P3 of the node device SW#3), in a similar manner to that according to the first embodiment. In this case, the node device SW#3 sets “No” as the result of the determination.

At step SC7, the node device SW#3 notifies all ports (in this case, the port P4 and the port P5) which are under the influence of the line K31 to disconnect the line. Accordingly, the ports P4 and P5 physically disconnect the connected lines (drop the optical or electrical levels), thereby generating a pseudo failure. At step SC6, the node device SW#3 updates the trunk management table 11 (see FIG. 8), in a similar manner to that according to the first embodiment.

Based on the generation of the pseudo failure, the node device Edge#3 and the node device Edge#4 as the connection destinations execute the above 1+1 switching to switch the active line from the pseudo failure-detected line to the backup line, thereby avoiding the failure and maintaining the connection.

In the second embodiment, the occurrence of a failure and the 1+1 switch instruction can be explicitly notified to the node device Edge#3 and the node device Edge#4 via other line (not shown) without generating a pseudo failure.

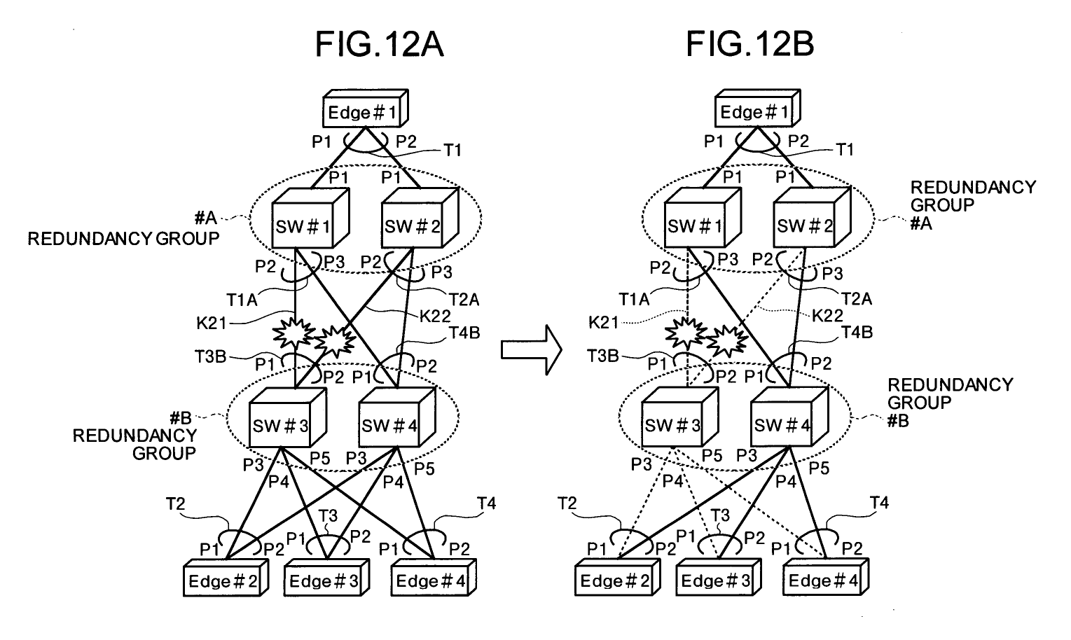

As shown in FIG. 12A, when a failure occurs in the entire lines (a line K21 and a line K22) that constitute the trunk T3B of the node device SW#3, a line disconnection occurs in each node device that uses a line concerning the node device SW#3 as an active line.

According to the second embodiment, as an operation example 2, in order avoid this influence, the node device SW#3 notifies the failure to all adjacent node devices, in a similar manner to that of the operation example 1. The node device SW#3 can notify the failure by notifying an explicit notification message or by physically disconnecting the line (dropping the optical or electrical levels).

Specifically, upon detecting the failure in the line K21 and the line K22, the node device SW#3 sets “Yes” as the result of the determination made at step SC1 shown in FIG. 13. At step SC2, the node device SW#3 determines whether there is a setting of a trunk in the failure-detected lines (in this case, the line K21 of the port P1 and the line K22 of the port P2 of the node device SW#3), in a similar manner to that according to the first embodiment. In this case, the node device SW#3 sets “Yes” as the result of the determination made.

At step SC3, the node device SW#3 determines whether the failure-detected lines include the active line (in this case, the line K21). In this case, the node device SW#3 sets “Yes” as the result of the determination made. At step SC4, the node device SW#3 determines whether the backup line (in this case, the line K22) is normal. In this case, the node device SW#3 sets “No” as the result of the determination made.

At step SC7, the node device SW#3 notifies the entire ports (in this case, the port P3, the port P4, and the port P5) which are under the influence of the line K21 and the line K22 to disconnect the lines. Accordingly, the port P3, the port P4, and the port P5 physically disconnect the connected lines (drop the optical and electrical levels), thereby generating a pseudo failure. At step SC6, the node device SW#3 updates the trunk management table 11 (see FIG. 8), in a similar manner to that according to the first embodiment.

Based on the generation of the pseudo failure, the node device Edge#2, the node device Edge#3, and the node device Edge#4 as the connection destinations execute the above 1+1 switching to switch the active line from the pseudo failure-detected line to the backup line, thereby avoiding the failure and maintaining the connection, as shown in FIG. 12B. When a result of the determination made at step SC4 is “Yes”, the 1+1 switching is executed at step SC5. When a result of the determination made at step SC3 is “No”, the processing at step SC6 is executed.

As explained above, according to the second embodiment, when a failure occurs, the occurrence of the failure is notified to the node devices as the connection destinations which are under the influence of the failure. Therefore, the traffic load at the time of switching due to the node failure can be decreased, and the line can be switched in a very short period.

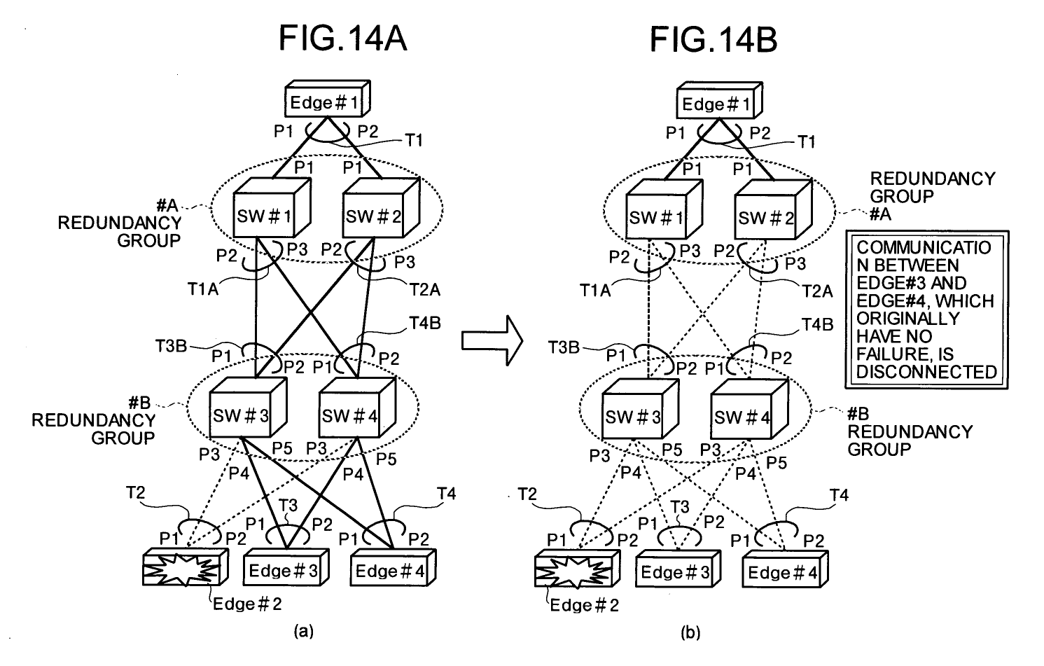

According to the second embodiment, when a failure occurs in the entire lines that constitute the trunk T2 of the node device Edge#2 (or when a failure occurs in the node device Edge#2) shown in FIG. 14A, the node device SW#3 and the node device SW#4 (the redundancy group #B) as the connection destinations cannot entirely function as shown in FIG. 14B.

In this case, even the communication between the node device Edge#3 and the node device Edge#4 that is irrelevant to the failure cannot be carried out.

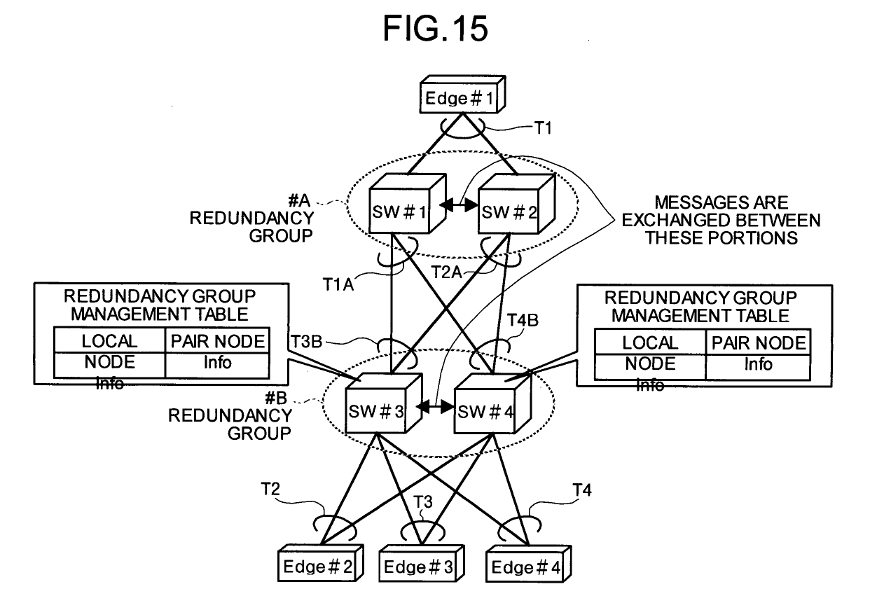

According to a third embodiment of the present invention, as shown in FIG. 15, an example of a configuration is explained that enables nodes constituting the same redundancy group to notify the own status to each other, thereby avoiding such a situation that the whole node devices within the redundancy group cannot entirely function due to the line failure.

In other words, each node device within the redundancy group has usually the same connection destination (the node device). When one node device has become unable to function, this arrangement is essential to enable this node device to hand over the connection to the other node device.

According to the third embodiment, node devices within the same redundancy group notify to each other the transfer capacity about the number of trunks that are operating normally (including lines that do not become a trunk to connect with the node device Edge#1 to the node device Edge#4) and the number of lines that are operating normally. With this arrangement, even when the whole node devices within the redundancy group need to be disconnected, at least one node device within the redundancy group remains in the operating status.

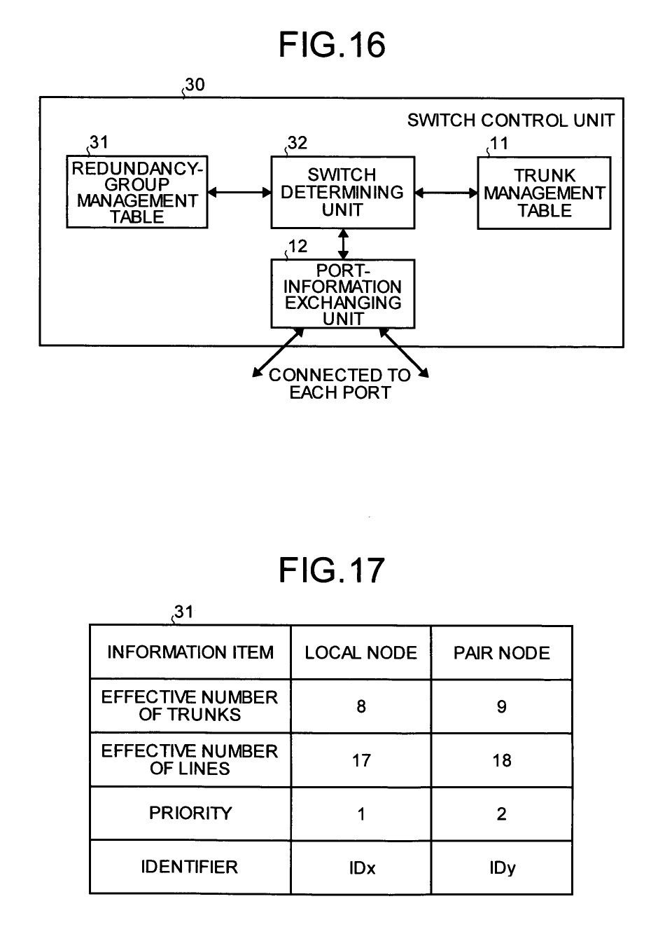

FIG. 16 is a block diagram of a configuration of a switch control unit 30 according to the third embodiment. The switch control unit 30 is provided in each of the node devices Edge#1 to Edge#4, and the node devices SW#1 to SW#4 shown in FIG. 15.

In FIG. 16, like parts corresponding to those in FIG. 7 are designated with like reference signs. In FIG. 16, a switch determining unit 32 is provided in place of the switch determining unit 13 shown in FIG. 7, and a redundancy group management table 31 is additionally provided.

The redundancy group management table 31 is used to manage each node device that constitutes the redundancy group, and, as shown in FIG. 17, has fields called an information item, a self node, and a pair node.

The self node expresses a node device having the redundancy group management table 31. The pair node corresponds to a node device that forms a pair with the self node. For example, in the case of the redundancy group management table 31 provided in the node device SW#3 in the redundancy group #B shown in FIG. 15, the self node corresponds to the node device SW#3, and the pair node corresponds to the node device SW#4.

The information item includes an effective number of trunks, an effective number of lines, priority, and an identifier. The effective number of trunks is an effective number of trunks set to the node device (the self node and the pair node). The effective number of lines is the effective number of lines connected to the node device. The priority expresses the priorities of the self node and the pair node. The identifier identifies the node device, and is an MAC address or the like.

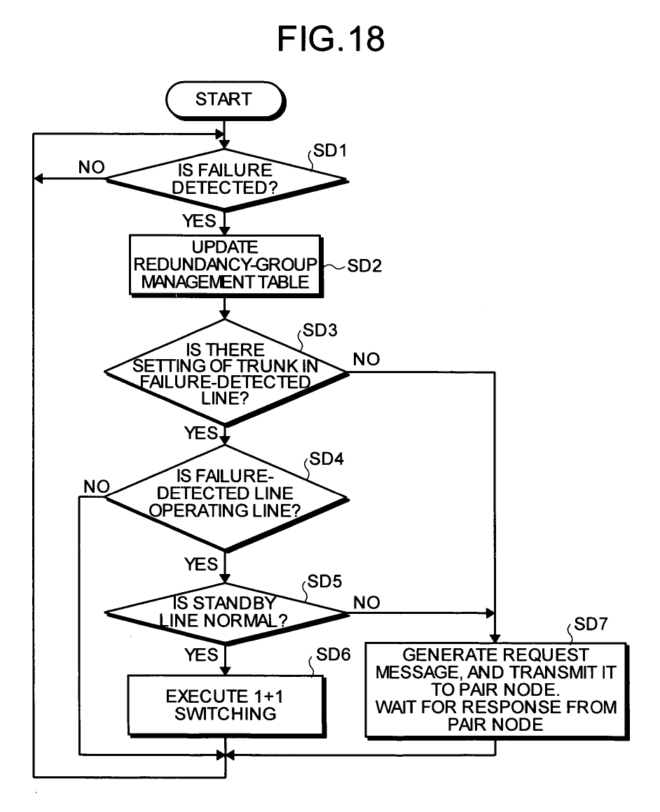

The operation according to the third embodiment is explained below with reference to flowcharts shown in FIG. 18 to FIG. 20. At step SD1 shown in FIG. 18, each node device (each of the node devices Edge#1 to Edge#4, and the node devices SW#1 to SW#4 shown in FIG. 15) determines whether a failure is detected in the device. In this case, each node device sets “No” as the result of the determination made, and repeats the same determination.

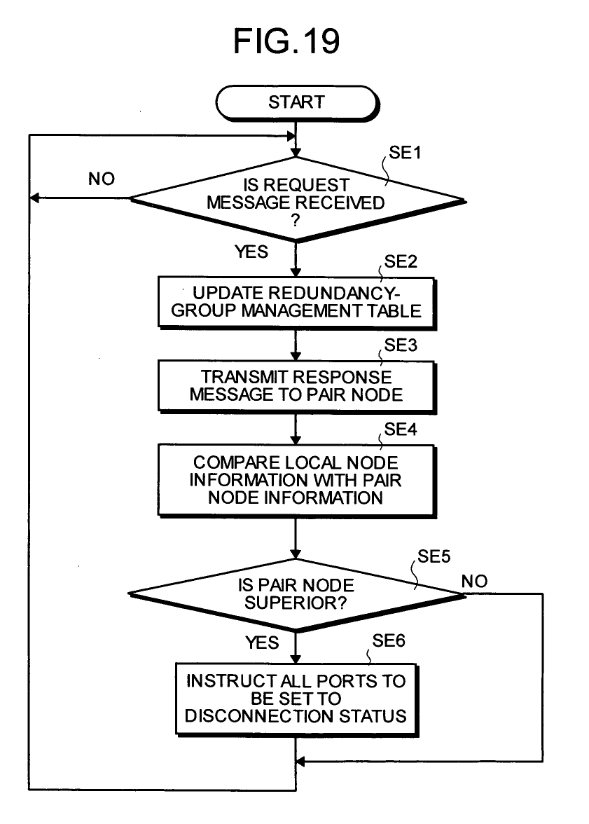

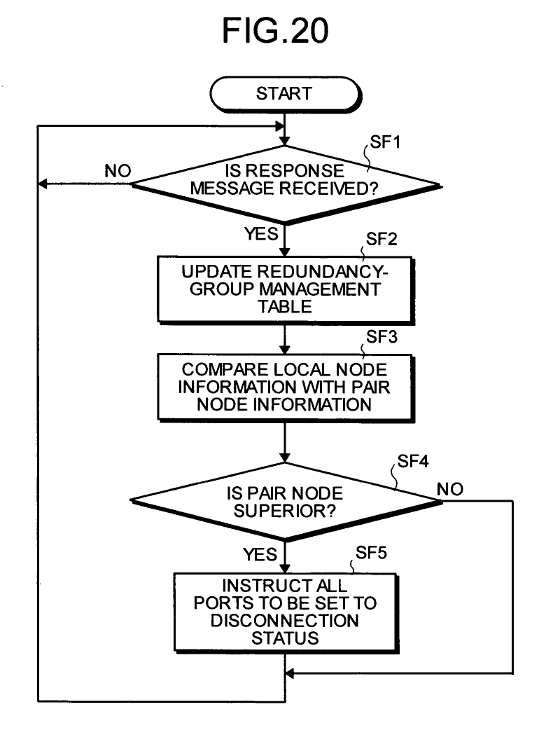

At step SE1 shown in FIG. 19, each node device determines whether a request message is received. In this case, each node device sets “No” as the result of the determination made, and repeats the same determination. At step SF1 shown in FIG. 20, each node device determines whether a response message is received. In this case, each node device sets “No” as the result of the determination made, and repeats the same determination.

When a failure occurs in the entire lines of the trunk T2 of the node device Edge#2 (or the node device Edge#2 itself) shown in FIG. 15 (see FIG. 14A), the node device SW#3 sets “Yes” as the result of the determination made at step SD1 shown in FIG. 18.

At step SD2, the node device SW#3 updates the redundancy group management table 31 (see FIG. 17) regarding the self node. Because the failure occurs in one line (corresponding to the trunk T2) of the node device SW#3, the node device SW#3 decrements by one the effective number of lines of the self node shown in FIG. 17.

When a failure occurs in the entire lines of the trunk of the self node or when a failure-detected line does not constitute a trunk, the node device SW#3 decrements by one the effective number of trunks of the self node. In this case, because the failure-detected line (corresponding to the trunk T2) does not constitute a trunk, the node device SW#3 decrements by one the effective number of trunks of the self node shown in FIG. 17.

At step SD3, the node device SW#3 determines whether a trunk is set in the failure-detected line. In this case, the node device SW#3 sets “No” as the result of the determination made.

At step SD7, the node device SW#3 generates a request message to the pair node (the node device SW#4) that constitutes the redundancy group #B, and transmits the request message to the pair node (the node device SW#4). This request message is a request to the pair node (in this case, the node device SW#4) to update the contents of the redundancy management table.

The request message contains the update contents of the redundancy table of the self node (the node device SW#3). The node device SW#3 is set in a status of a standby for a response from the pair node (the node device SW#4).

Similarly, when a failure occurs in the entire lines of the trunk T2 of the node device Edge#2 (or the node device Edge#2 itself) shown in FIG. 15 (see FIG. 14A), the node device SW#4 sets “Yes” as the result of the determination made at step SD1 shown in FIG. 18.

At step SD2, the node device SW#4 updates the redundancy group management table 31 (see FIG. 17) regarding the self node. Because the failure occurs in one line (corresponding to the trunk T2) of the node device SW#4, the node device SW#4 decrements by one the effective number of lines of the self node shown in FIG. 17.

When a failure occurs in the entire lines of the trunk of the self node or when a failure-detected line does not constitute a trunk, the node device SW#4 decrements by one the effective number of trunks of the self node. In this case, because the failure-detected line (corresponding to the trunk T2) does not constitute a trunk, the node device SW#4 decrements by one the effective number of trunks of the self node shown in FIG. 17.

At step SD3, the node device SW#4 determines whether a trunk is set in the failure-detected line. In this case, the node device SW#4 sets “No” as the result of the determination made.

At step SD7, the node device SW#4 generates a request message to the pair node (the node device SW#3) that constitutes the redundancy group #B, and transmits the request message to the pair node (the node device SW#3). This request message is a request to the pair node (in this case, the node device SW#3) to update the contents of the redundancy management table.

The request message contains the update contents of the redundancy table of the self node (the node device SW#4). The node device SW#4 is set in a status of a standby for a response from the pair node (the node device SW#3).

When the node device SW#4 receives a request message from the node device SW#3, the node device SW#4 sets “Yes” as the result of the determination made at step SE1 shown in FIG. 19. At step SE2, the node device SW#4 updates the contents of the pair node (the node device SW#3) in the redundancy group management table 31 based on the update contents included in the request message.

At step SE3, the node device SW#4 generates a response message to the pair node (the node device SW#3) that constitutes the redundancy group #B, and transmits the response message to the pair node (the node device SW#3). This response message contains the update contents of the self node in the redundancy management table provided in the self node (in this case, the node device SW#4).

At step SE4, the node device SW#4 compares the information (the effective number of trunks, the effective number of lines, and the priority) of the self node with the corresponding information of the pair node in the redundancy group management table 31. At step SE5, the node device SW#4 determines whether the pair node is superior to the self node. That the pair node is superior to the self node means that the pair node has a larger effective number of trunks, a larger effective number of lines, or a higher priority than those of the self node. In other words, this means that the transfer capacity of the pair node is higher than that of the self node.

When a result of the determination made at step SE5 is “Yes”, the node device SW#4 issues, at step SE6, an instruction to disconnect the entire ports (disconnect the optical signal), and notifies the counter node devices (the whole adjacent nodes) to use the line connected to the pair node (the node device SW#3) as an active line. When a result of the determination made at step SE5 is “No”, the node device SW#4 determines at step SE1.

With this arrangement, even when a failure occurs in the trunk T2 of the node device Edge#2, a line disconnection can be minimized, and the communication between the lines having no relation with the failure trunk (for example, the lines of the node device SW#3, the node device Edge#3, and the node device Edge#4) can be maintained.

When the node device SW#3 receives a response message from the node device SW#4, the node device SW#3 sets “Yes” as the result of the determination made at step SF1 shown in FIG. 20.

At step SF2, the node device SW#3 updates the contents of the pair node (the node device SW#4) in the redundancy group management table 31 based on the update contents included in the response message.

At step SF3, the node device SW#3 compares the information (the effective number of trunks, the effective number of lines, and the priority) of the self node with the corresponding information of the pair node in the redundancy group management table 31. At step SF4, the node device SW#3 determines whether the pair node is superior to the self node, in a similar manner to that at step SE5 (see FIG. 19).

When a result of the determination made at step SF4 is “No”, the node device SW#3 determines at step SF1. When a result of the determination made at step SF4 is “Yes”, the node device SW#3 issues, at step SF5, an instruction to set the entire ports (lines) to a disconnection status (disconnect the optical signal), and notifies the counter node devices to use the line connected to the pair node (the node device SW#4) as an active line.

When a result of the determination made at step SD3 shown in FIG. 18 is “Yes”, each node device determines, at step SD4, whether the failure-detected line is an active line. When a result of the determination made at step SD4 is “No”, each node device determines at step SD1.

On the other hand, when a result of the determination made at step SD4 is “Yes”, each node device determines at step SD5 whether the backup line is normal. When a result of the determination made at step SD5 is “Yes”, each node device executes, at step SC5, the 1+1 switching in a similar manner to that at step SC5 (see FIG. 13). When a result of the determination made at step SD5 is “No”, each node device executes the processing at step SD7.

As explained above, according to the third embodiment, node devices within the redundancy group notify their communication capacities to each other. When a failure occurs, among plural node devices within the redundancy group, a node device having a higher communication capacity executes communication. Therefore, it is possible to carry out communication using the node device having a higher communication capacity.

According to the third embodiment, an example of a configuration is explained. Node devices within a redundancy group exchange information (the effective number of trunks, the effective number of lines, and priority) concerning a transfer capacity. A node device having a failure issues an instruction to other node devices to set the entire ports (lines) to a disconnection status (the optical signal is disconnected). The node device notifies the counter node devices to use the line connected to the pair node (the node device SW#4) as an active line. Alternatively, the transfer capacity can be notified directly to the counter node devices. An example of this configuration is explained below as a fourth embodiment of the present invention.

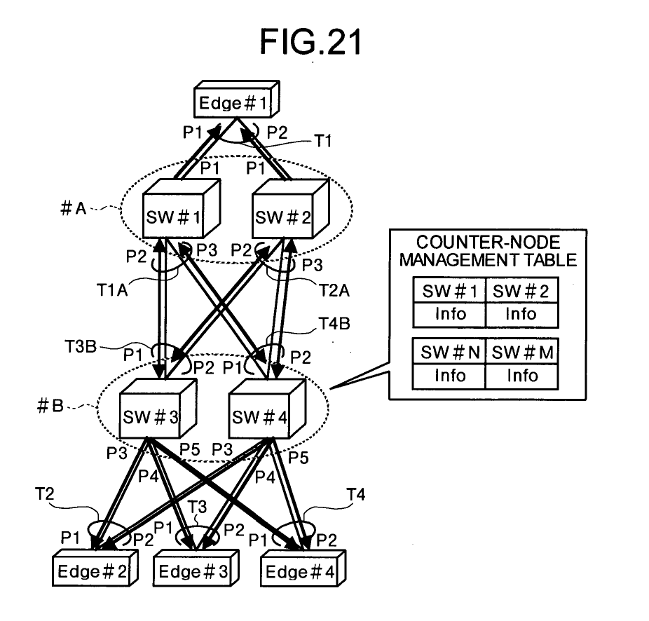

FIG. 21 is a block diagram of a configuration of a node-redundancy control apparatus according to the fourth embodiment. In FIG. 21, like parts corresponding to those in FIGS. 14A and 15 are designated with like reference signs.

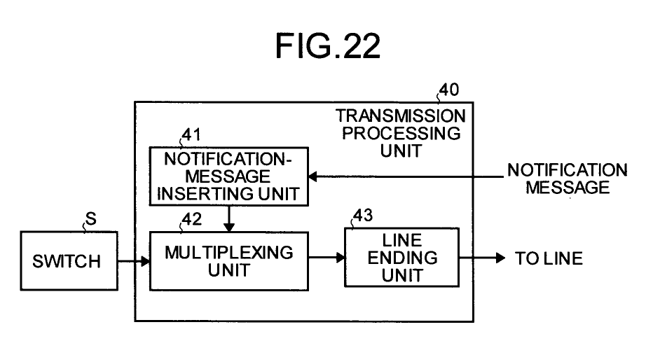

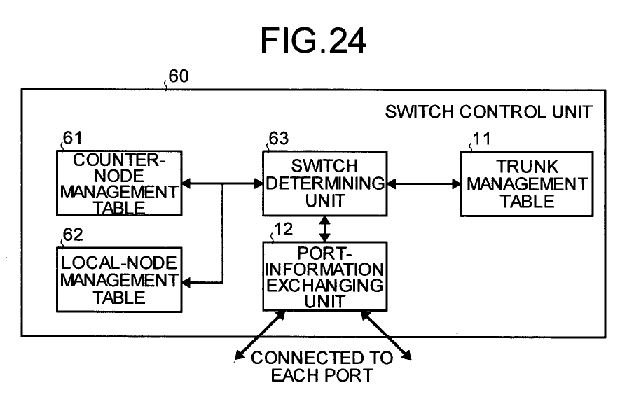

In the fourth embodiment, each port of each node device has a transmission processing unit 40 shown in FIG. 22. In the transmission processing unit 40, a notification message inserting unit 41 receives a notification message generated by a switch control unit 60 (see FIG. 24) when a failure occurs, and delivers this notification message to a multiplexing unit 42. The multiplexing unit 42 multiplexes a frame from the switch S and the notification message. A line terminating unit 43 is connected to the line, and transmits a multiplexed frame.

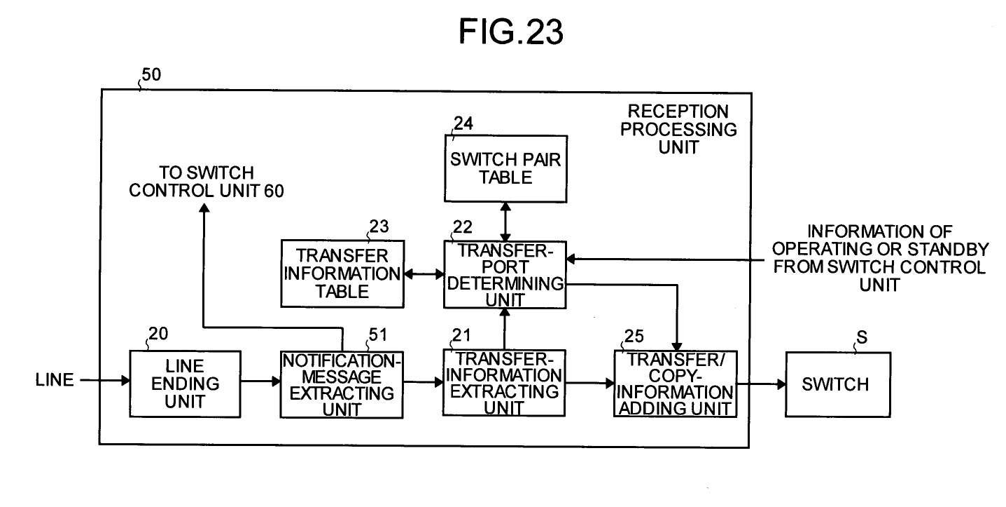

According to the fourth embodiment, a reception processing unit 50 shown in FIG. 23 is used in each port of each node device. In FIG. 23, like parts corresponding to those in FIG. 4 are designated with like reference signs.

In the reception processing unit 50, a notification message extracting unit 51 extracts a notification message (see FIG. 22) from a multiplexed frame transmitted from the counter node device, and delivers this notification message to a switch control unit 60 (see FIG. 24).

According to the fourth embodiment, the switch control unit 60 shown in FIG. 24 is used in each port of each node device. In FIG. 24, like parts corresponding to those in FIG. 7 are designated with like reference signs.

In the switch control unit 60, a counter node management table 61 is set in a trunk unit, and is used to manage each counter node device opposite to the node device (the self node).

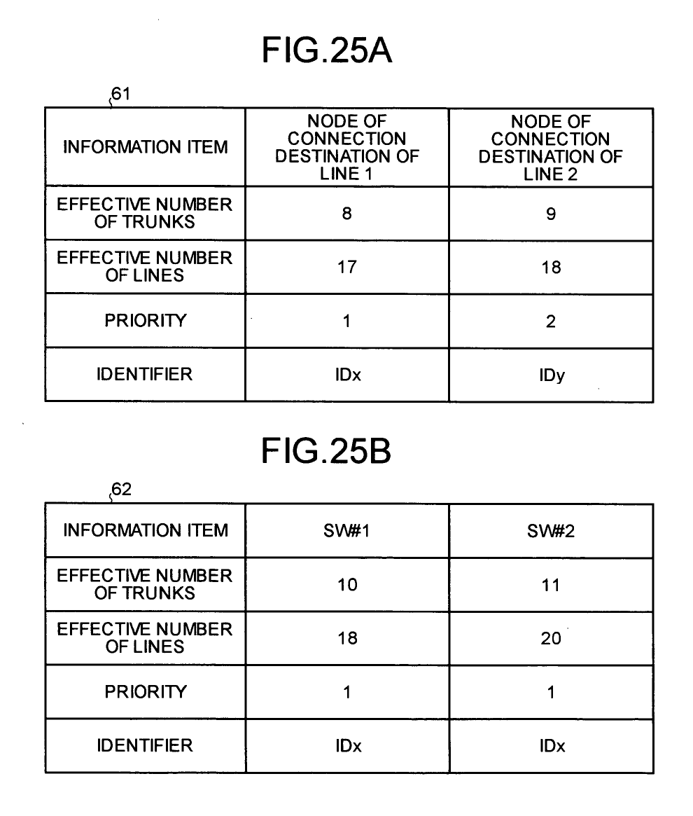

Specifically, as shown in FIG. 25A, the counter node management table 61 includes fields called an information item, a node of a connection destination of a line 1, and a node of a connection destination of a line 2. Actually, the node device has the counter node management table 61 for each one trunk.

The node of a connection destination of the line 1 corresponds to a node of the connection destination of the line 1 that constitutes the trunk (the counter node device). The node of a connection destination of the line 2 corresponds to a node of the connection destination of the line 2 that constitutes the trunk (the counter node device). In other words, the trunk includes the line 1 and the line 2.

The information item is identifiers of the effective number of trunks, the effective number of lines, and the priority. The effective number of trunks is the effective number of trunks set in each counter node device (nodes of the connection destinations of the lines 1 and 2). The effective number of lines is the effective number of lines connected to each counter node device. The priority expresses the priority of each counter node device. The identifier identifies each counter node device, and is an MAC address or the like.

Referring back to FIG. 24, a self node management table 62 is used to manage the self node, and, as shown in FIG. 25B, includes information of the effective number of trunks, the effective number of lines, the priority, and the identifier concerning the self node. A switch determining unit 63 updates the self node management table 62, and determines the 1+1 switching based on the counter node management table 61.

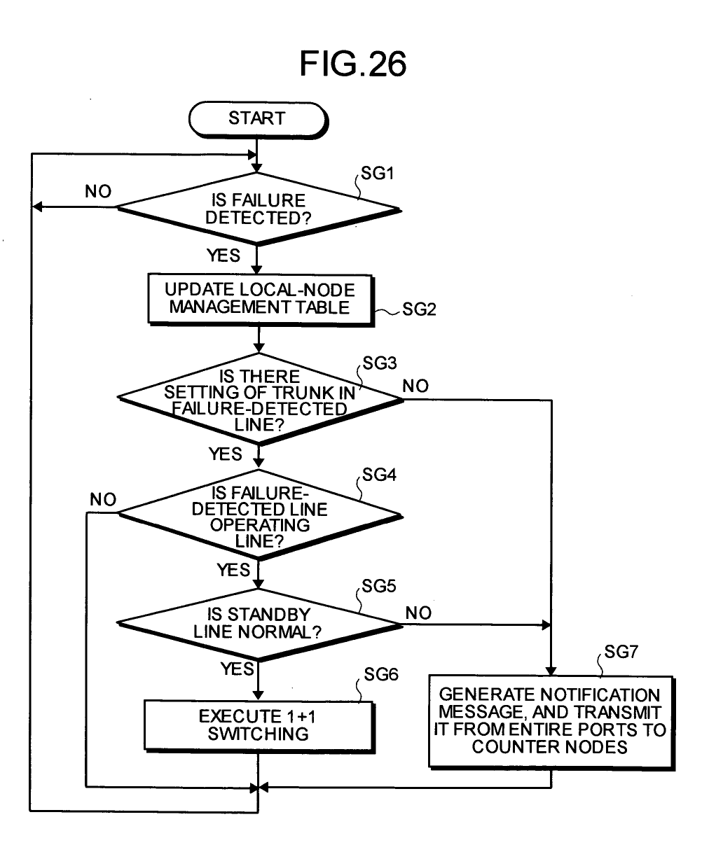

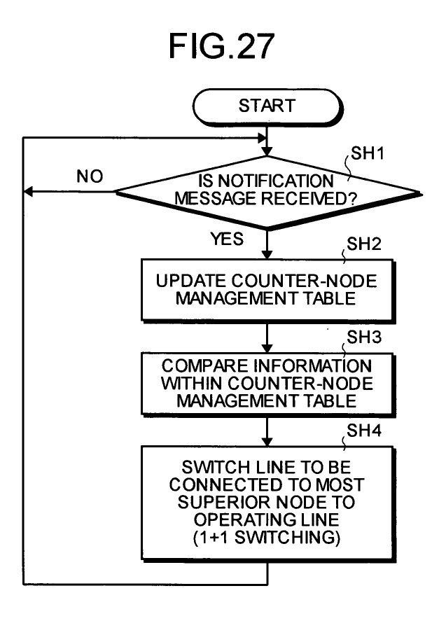

The operation of the node-redundancy control apparatus according to the fourth embodiment is explained next with reference to flowcharts shown in FIGS. 26 and 27. At step SG1 shown in FIG. 26, the switch determining unit 63 (see FIG. 24) of each node device (each of the node devices Edge#1 to Edge#4, and the node devices SW#1 to SW#4 shown in FIG. 21) determines whether the node device detects a failure. In this case, the switch determining unit 63 sets “No” as the result of the determination made, and repeats the same determination.

At step SH1 shown in FIG. 27, the switch determining unit 63 of each node device determines whether the node device receives a notification message from the counter node device. In this case, the switch determining unit 63 sets “No” as the result of the determination made, and repeats the same determination.

When a failure occurs in the entire lines of the trunk T2 of the node device Edge#2 (or the node device Edge#2 itself) shown in FIG. 21, the switch determining unit 63 of the node device SW#3 sets “Yes” as the result of the determination made at step SG1 shown in FIG. 26.

At step SG2, the switch determining unit 63 of the node device SW#3 updates the self node management table 62 (see FIG. 25B) regarding the self node. Because the failure occurs in one line (corresponding to the trunk T2) of the node device SW#3, the switch determining unit 63 of the node device SW#3 decrements by one the effective number of lines of the self node shown in FIG. 25B.

When a failure occurs in the entire lines of the trunk of the self node or when a failure-detected line does not constitute a trunk, the switch determining unit 63 of the node device SW#3 decrements by one the effective number of trunks of the self node. In this case, because the failure-detected line (corresponding to the trunk T2) does not constitute a trunk, the switch determining unit 63 of the node device SW#3 decrements by one the effective number of trunks of the self node shown in FIG. 25B.

At step SG3, the switch determining unit 63 of the node device SW#3 determines whether a trunk is set in the failure-detected line. In this case, the switch determining unit 63 of the node device SW#3 sets “No” as the result of the determination made.

At step SG7, the node device SW#3 generates a notification message to the counter node devices (in this case, the node device SW#1, the node device SW#2, the node device Edge#2, the node device Edge#3, and the node device SW#4), delivers the notification message to the notification message inserting unit 41 (see FIG. 22), and transmits the notification message to each counter node. The notification message contains the update contents of the redundancy table of the self node (the node device SW#3).

Similarly, when a failure occurs in the entire lines of the trunk T2 of the node device Edge#2 (or the node device Edge#2 itself) shown in FIG. 21 (see FIG. 14A), the switch determining unit 63 of the node device SW#4 sets “Yes” as the result of the determination made at step SG1 shown in FIG. 26.

At step SG2, the switch determining unit 63 of the node device SW#4 updates the self node management table 62 (see FIG. 25B) regarding the self node. Because the failure occurs in one line (corresponding to the trunk T2) of the node device SW#4, the switch determining unit 63 of the node device SW#4 decrements by one the effective number of lines of the self node shown in FIG. 25B.

When a failure occurs in the entire lines of the trunk of the self node or when a failure-detected line does not constitute a trunk, the switch determining unit 63 of the node device SW#4 decrements by one the effective number of trunks of the self node. In this case, because the failure-detected line (corresponding to the trunk T2) does not constitute a trunk, the switch determining unit 63 of the node device SW#4 decrements by one the effective number of trunks of the self node shown in FIG. 25B.

At step SG3, the switch determining unit 63 of the node device SW#4 determines whether a trunk is set in the failure-detected line. In this case, the switch determining unit 63 of the node device SW#4 sets “No” as the result of the determination made.

At step SG7, the node device SW#4 generates a notification message to the counter node devices (in this case, the node device SW#1, the node device SW#2, the node device Edge#2, the node device Edge#3, and the node device Edge#4), delivers the notification message to the notification message inserting unit 41 (see FIG. 22), and transmits the notification message to each counter node. The notification message contains the update contents of the redundancy table of the self node (the node device SW#4).

When the node device Edge#3 receives the notification messages from the node device SW#3 and the node device SW#4, the switch determining unit 63 of the node device Edge#3 sets “Yes” as the result of the determination made at step SH1 shown in FIG. 27.

At step SH2, the switch determining unit 63 of the node device Edge#3 updates the contents of the nodes of the connection destinations of the counter node management table 61 (the node device SW#3 and the node device SW#4), based on the update contents of the self node tables of the node device SW#3 and the node device SW#4 contained in the notification message.

At step SH3, the switch determining unit 63 of the node device Edge#3 compares the information (the effective number of trunks, the effective number of lines, and the priority) of the node of the connection destination of the line 1 with the corresponding information of the node of the connection destination of the line 2 in the counter node management table 61. At step SH4, the switch determining unit 63 of the node device Edge#3 switches the line (port) connected to the most superior node device to the active line, and determines at step SH1.

The superior node device means that the node device has a larger effective number of trunks, a larger effective number of lines, or a higher priority than those of the other node device. In other words, this means that the transfer capacity of the node device is higher than that of the other node device.

In the other counter node devices (the node device SW#1, the node device SW#2, the node device Edge#2, and the node device Edge#4) that receive the notification message, the 1+1 switching is also executed through the operation similar to that of the node device Edge#3.

When a result of the determination made at step SG3 shown in FIG. 26 is “Yes”, each node device determines, at step SG4, whether the failure-detected line is the active line. When a result of the determination made at step SG4 is “No”, each node device determines at step SG1.

On the other hand, when a determination made at step SG4 is “Yes”, each node device determines, at step SG5, whether the backup line is normal. When a determination made at step SG5 is “Yes”, each node device executes, at step SG6, the 1+1 switching in a similar manner to that at step SC5 (see FIG. 13). When a result of the determination made at step SG5 is “No”, each node device executes the processing at step SG7.

As explained above, according to the fourth embodiment, a node device having the most superior transfer capacity within a redundancy group can continue the transfer processing without disconnecting the entire port within the redundancy group.

According to the first embodiment, the 1+1 switching can be forcibly executed using a control command input by the manager. An example of this configuration is explained below as a fifth embodiment of the present invention.

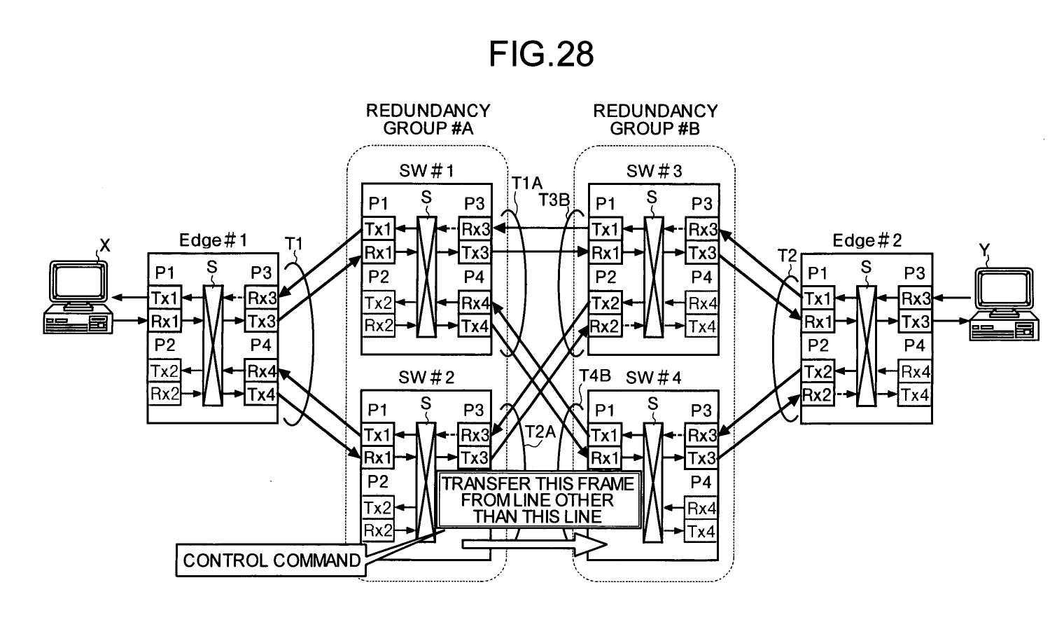

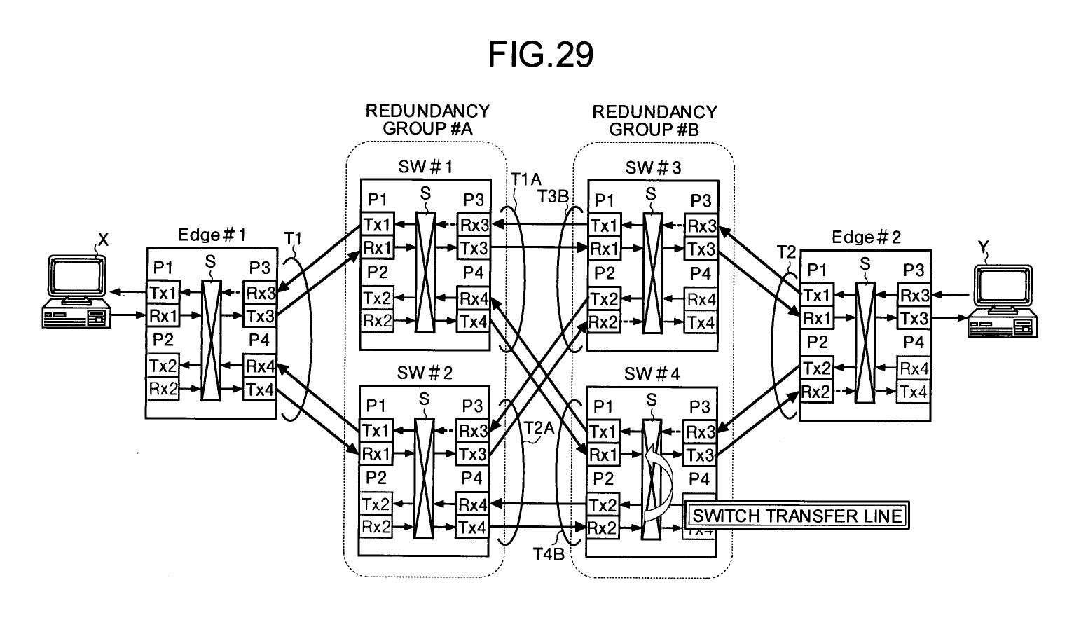

FIGS. 28 and 29 are block diagrams of a configuration of a node-redundancy control apparatus for explaining the operation according to the fifth embodiment. In FIGS. 28 and 29, like parts corresponding to those in FIG. 1 are designated with like reference signs.

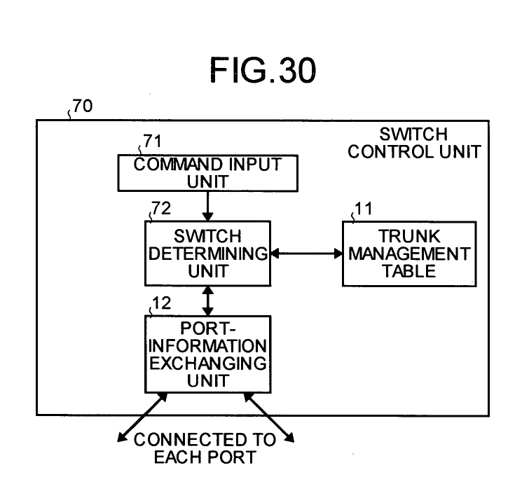

According to the fifth embodiment, a switch control device 70 shown in FIG. 30 is used in each port of each node device. In FIG. 30, like parts corresponding to those in FIG. 7 are designated with like reference signs.

In a switch control unit 70, the manager inputs a control command from a command input unit 71. The control command is used to prohibit the node device at the connection destination of the operating circuit from using the active line, and forcibly instruct the 1+1 switching. A switch determining unit 72 executes the processing based on the control command in addition to the function of the switch determining unit 13 (see FIG. 7).

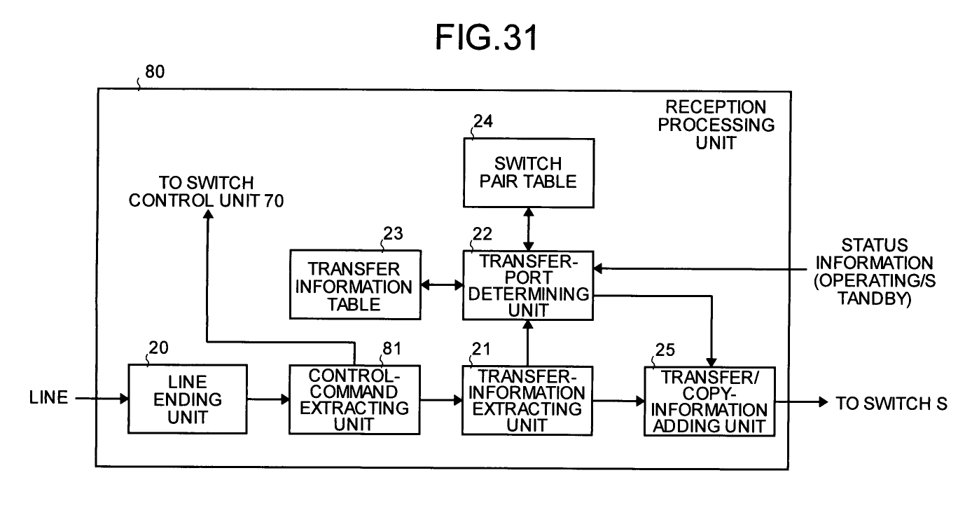

According to the fifth embodiment, a reception processing unit 80 shown in FIG. 31 is used in each port of each node device. In FIG. 31, like parts corresponding to those in FIG. 4 are designated with like reference signs.

In the reception processing unit 80, a control command extracting unit 81 extracts the control command from a frame transmitted from the node device, and delivers the control command to the switch control unit 70 (see FIG. 30).

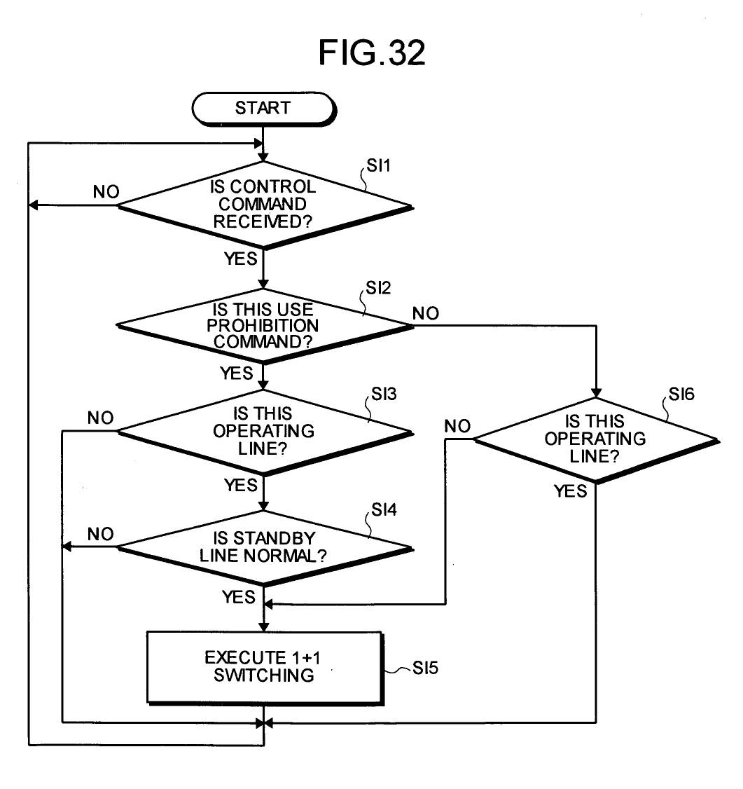

The operation of the node-redundancy control apparatus according to the fifth embodiment is explained below with reference to a flowchart shown in FIG. 32. At step SI1 shown in FIG. 32, the switch determining unit 72 (see FIG. 30) of each node device determines whether the node device receives a control command. In this case, the switch determining unit 72 sets “No” as the result of the determination made, and repeats the determination.

As shown in FIG. 28, when the manager inputs the control command to the command input unit (see FIG. 30) of the node device SW#2, the switch determining unit 72 transmits the control command to the node device SW#4. The control command is a use prohibiting command to prohibit the node device SW#4 that uses the active line from using the active line, and switch the active line to the backup line.

When the node device SW#4 receives the control command (the use prohibiting command), the switch determining unit 72 of the node device SW#4 sets “Yes” as the result of the determination made at step SI1.

At step SI2, the switch determining unit 72 of the node device SW#4 determines whether the control command is the use prohibiting command. In this case, the switch determining unit 72 sets “Yes” as the result of the determination made.

At step SI3, the switch determining unit 72 of the node device SW#4 determines whether the line that receives the control command (the use prohibiting command) is the backup line. In this case, the switch determining unit 72 sets “Yes” as the result of the determination made. At step SI4, the switch determining unit 72 of the node device SW#4 determines whether the backup line is normal. In this case, the switch determining unit 72 sets “Yes” as the result of the determination made.

At step SI5, the switch determining unit 72 of the node device SW#4 forcibly switches the active line from the port P2 (the active line) to the port P1 (the backup line) as shown in FIG. 29.

When a result of the determination made at step SI3 or step SI4 is “No”, the switch determining unit 72 determines at step SI1. When a result of the determination made at step SI2 is “No”, the switch determining unit 72 determines, at step SI6, whether a line that receives a control command (other than the use prohibiting command) is the active line.

When a result of the determination made step SI6 is “No”, the switch determining unit 72 executes the processing at step SI5. On the other hand, when a result of the determination made at step SI6 is “Yes”, the switch determining unit 72 determines at step SI1.

As explained above, according to the fifth embodiment, the switch determining unit 72 forcibly switches the active line of the other node device to the backup line by remote control based on the input of a control command. Therefore, convenience for the manager can be increased.

According to the fifth embodiment, it is explained that the node device SW#4, for example, executes the 1+1 switching by remote control based on the control command input by the node device SW#2, as shown in FIGS. 28 and 29. Alternatively, the node device SW#4 can locally execute the 1+1 switching based on the control command input by the node device SW#4. An example of this configuration is explained below as a sixth embodiment of the present invention.

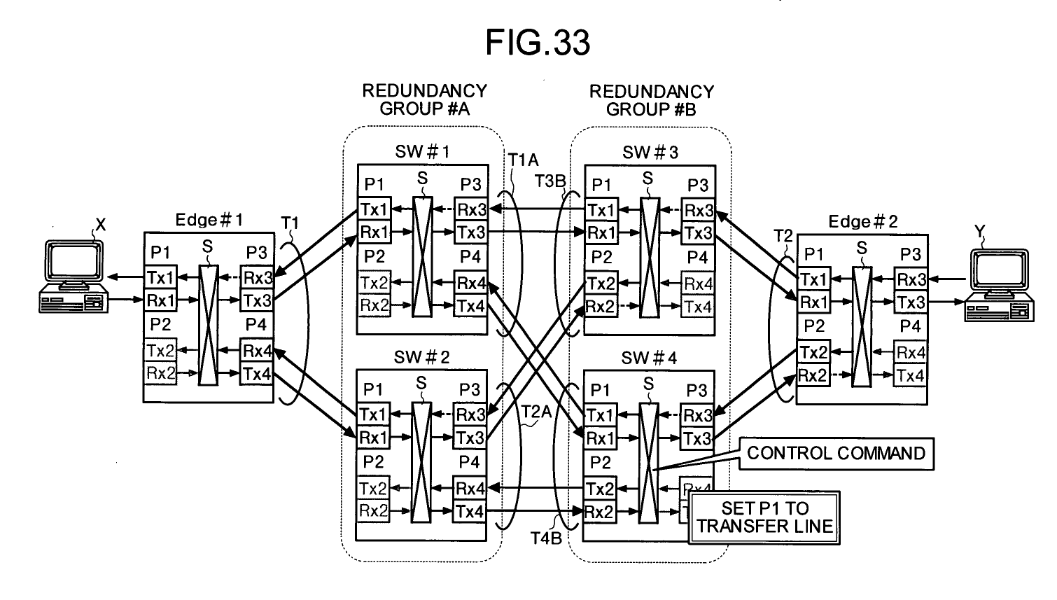

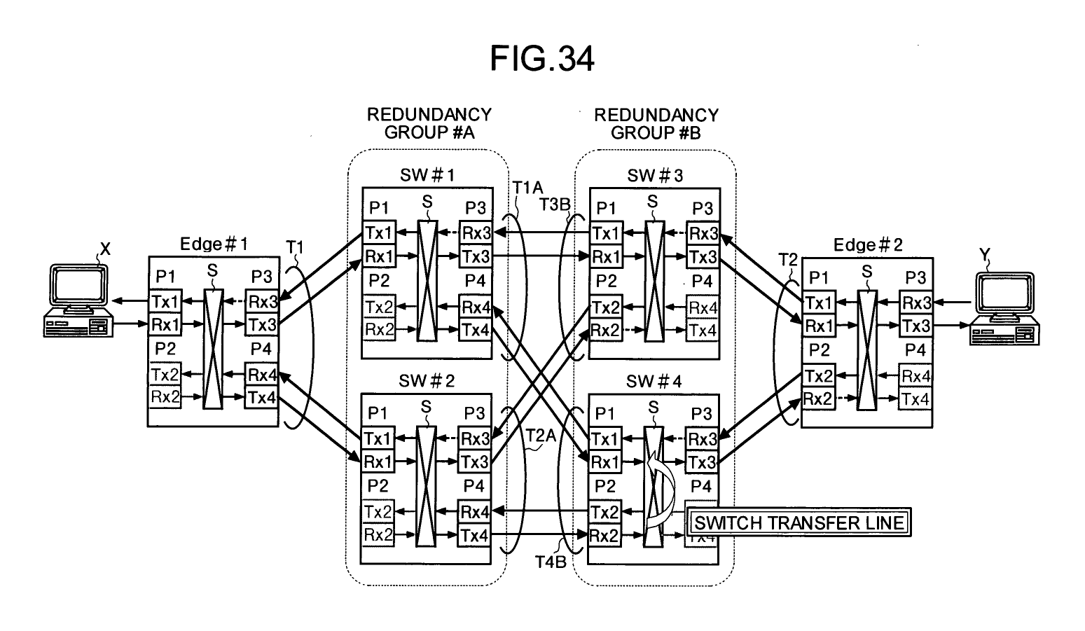

FIGS. 33 and 34 are block diagrams of a configuration of a node-redundancy control apparatus for explaining the operation according to the sixth embodiment. According to the sixth embodiment, the configuration of the device is the same as that according to the fifth embodiment.

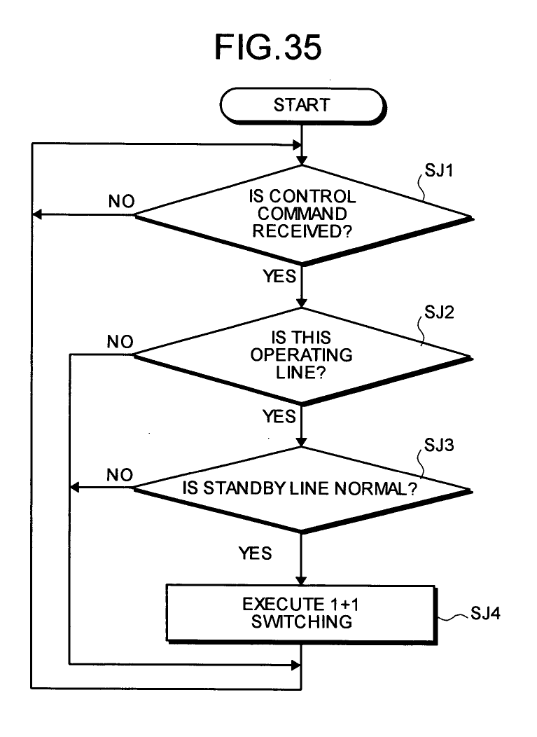

The operation of the device according to the sixth embodiment is explained below with reference to a flowchart shown in FIG. 35. At step SJ1 shown in FIG. 35, the switch determining unit 72 (see FIG. 30) of each node device determines whether the manager inputs a control command from the command input unit 71. In this case, the switch determining unit 72 sets “No” as the result of the determination made, and repeats the determination.

As shown in FIG. 33, when the manager inputs the control command to the command input unit 71 (see FIG. 30) of the node device SW#4, the switch determining unit 72 sets “Yes” as the result of the determination made at step SJ1 shown in FIG. 35.

At step SJ2, the switch determining unit 72 of the node device SW#4 determines whether the line (in this case, the line of the port P2) corresponding to the control command is the active line. In this case, the switch determining unit 72 sets “Yes” as the result of the determination made.

At step SJ3, the switch determining unit 72 of the node device SW#4 determines whether the backup line (in this case, the line of the port P1) is normal. In this case, the switch determining unit 72 sets “Yes” as the result of the determination made.

At step SJ4, the switch determining unit 72 of the node device SW#4 forcibly and locally switches the active line from the port P2 (the active line) to the port P1 (the backup line) as shown in FIG. 34.

When a result of the determination made at step SJ2 or step SJ3 is “No”, the switch determining unit 72 determines at step SJ1.

As explained above, according to the sixth embodiment, based on the input of a control command, the active line of the self node device is locally switched to the backup line. Therefore, convenience for the user can be increased.

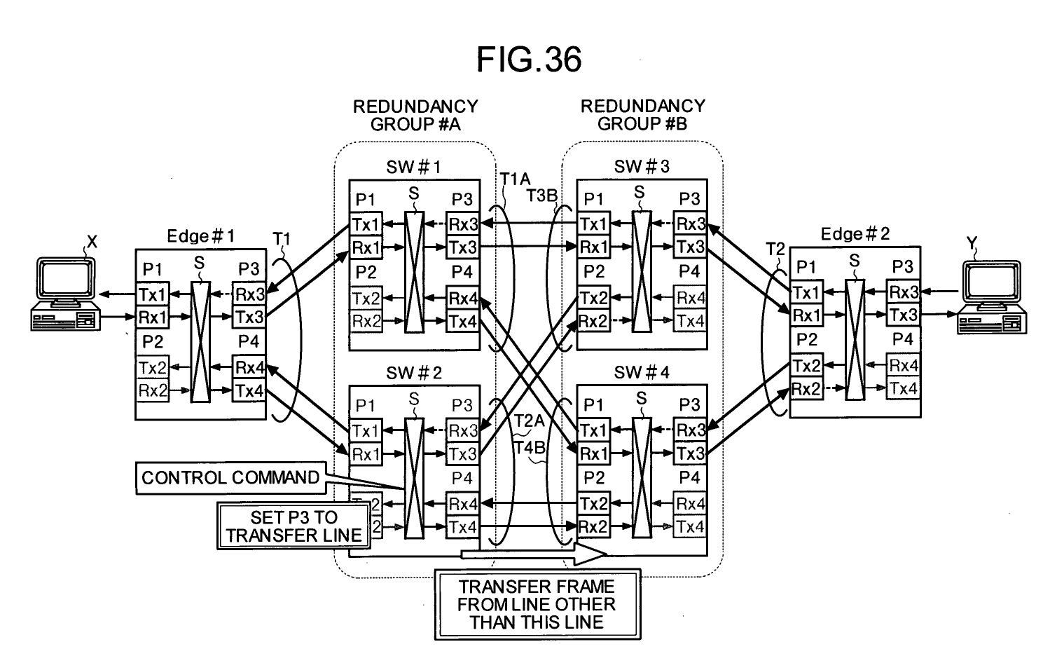

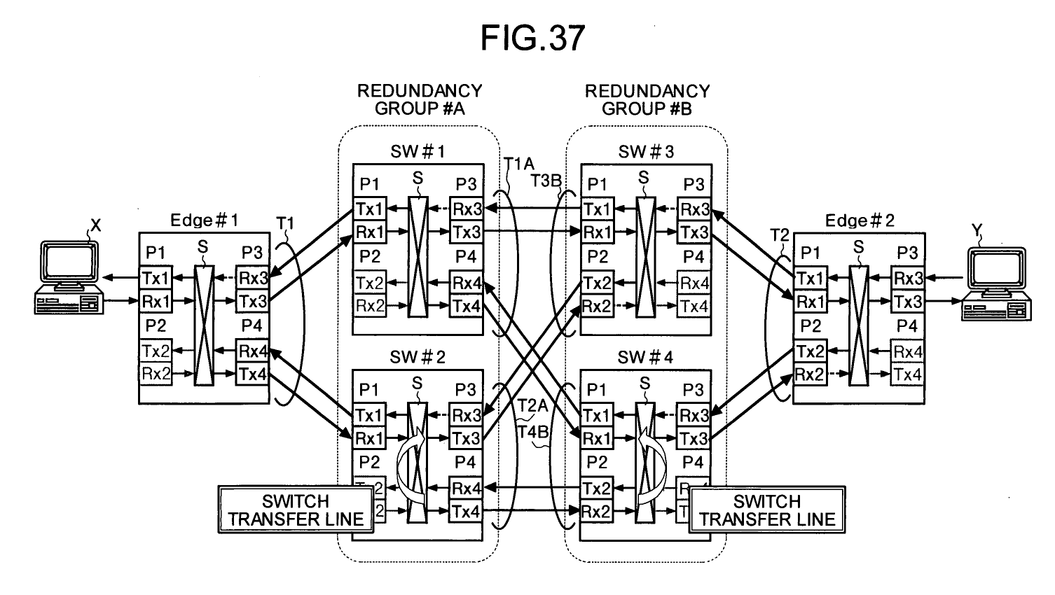

FIGS. 36 and 37 are block diagrams of a configuration of a node-redundancy control apparatus for explaining the operation according to a seventh embodiment of the present invention. The seventh embodiment is a combination of the fifth embodiment and the sixth embodiment.

In other words, when the node device SW#2 shown in FIG. 36 is input with a remote control command (the use prohibiting command) to control the node device SW#4, the active line of the node device SW#4 is forcibly switched from the port P2 (the active line) to the port P1 (the backup line) by remote control as shown in FIG. 37.

When the node device SW#2 shown in FIG. 36 is input with a local control command to control the node device SW#2, the active line of the node device SW#2 is forcibly switched from the port P4 (the active line) to the port P3 (the backup line) by local control as shown in FIG. 37.

As explained above, according to the seventh embodiment, effects similar to those obtained from the fifth embodiment and the sixth embodiment are obtained.

According to the first embodiment, two VLANs (Virtual Local Area Networks) can be configured in the communication network using a VLAN technique. One VLAN has a redundancy and the other VLAN has no redundancy. An example of this configuration is explained below as an eighth embodiment of the present invention.

The VLAN is a technique of creating a virtual group using only a specific node on a LAN without depending on a physical connection mode of a cable and a machine in the LAN. The VLAN is provided as an additional function to a router or a hub.

In the VLAN, nodes that are present on physically separate segments are collected to provide a virtual group of nodes that look like as if the nodes are present on the same segment. Therefore, a network can be flexibly configured or the configuration can be changed, without depending on a physical connection mode of the nodes. For example, two sections on separate floors can be regarded as logically one segment, or nodes present at separate positions can virtually participate in the original segment.

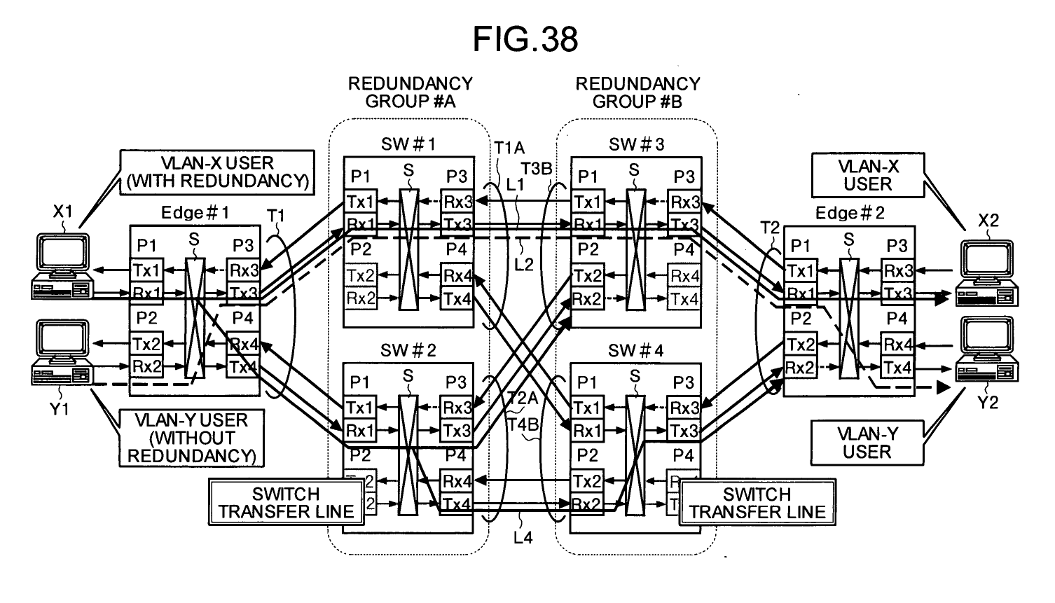

FIG. 38 is a block diagram of a configuration of a node-redundancy control apparatus for explaining the operation according to the eighth embodiment of the present invention. In FIG. 38, like parts corresponding to those in FIG. 1 are designated with like reference signs. In the communication network system shown in FIG. 38, a VLAN-X that connects between a terminal X1 and a terminal X2 and a VLAN-Y that connects between a terminal Y1 and a terminal Y2 are set as two VLANs.

The terminal X1 is connected to the port P1 of the node device Edge#1. The terminal X2 is connected to the port P3 of the node device Edge#2. The terminal Y1 is connected to the port P2 of the node device Edge#1. The terminal Y2 is connected to the port P4 of the node device Edge#2.

The VLAN-X has a redundancy. In other words, in the VLAN-X, routes L3 and L4 of the backup line are set in addition to a route L1 of the active line. Therefore, when a failure occurs in the route L1 of the active line, the route L3 and the route L4 of the backup line can take redundancy, thereby avoiding the failure.

On the other hand, the VLAN-Y has no redundancy. In other words, in the VLAN-Y, no route of a backup line is set in addition to a route L2 of the active line. Therefore, when a failure occurs in the route L2 of the active line, there is no redundancy.

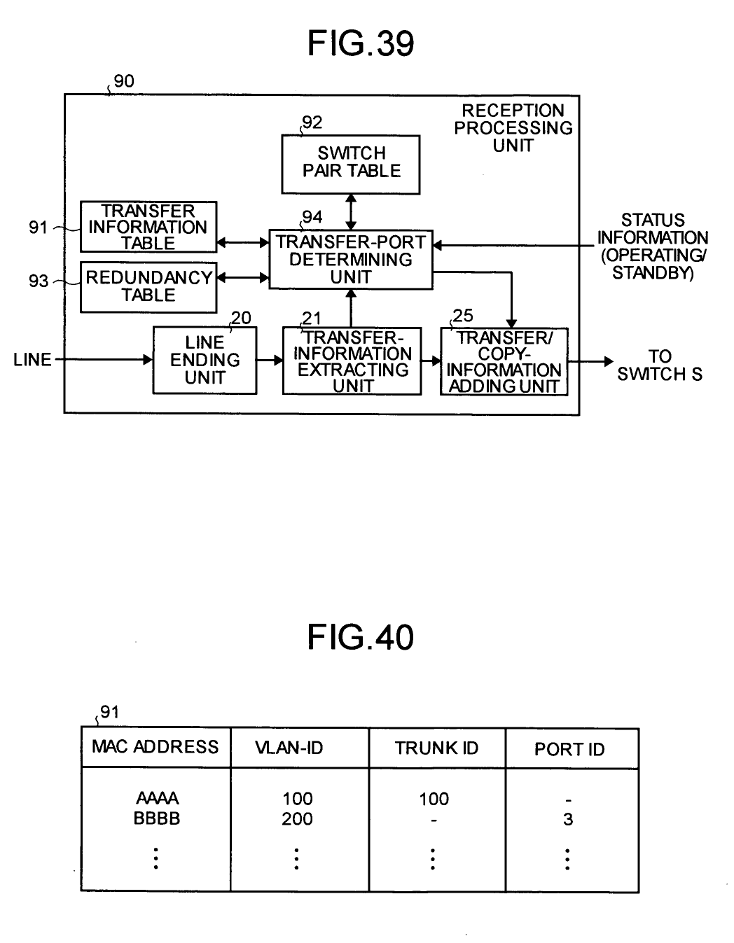

According to the eighth embodiment, a reception processing unit 90 shown in FIG. 39 is used in each port of each node device. In FIG. 39, like parts corresponding to those in FIG. 4 are designated with like reference signs.

In the reception processing unit 90, a transfer information table 91 expresses a relationship between an MAC address, a VLAN-ID, a trunk ID, and a port ID as shown in FIG. 40. The MAC address is transfer information extracted by the transfer information extracting unit 21.

The VLAN-ID is an identifier to identify a frame corresponding to the VLAN-X or the VLAN-Y, and is prescribed by the IEEE802.1Q. For example, VLAN-ID=100 is an identifier of a frame corresponding to the VLAN-X. On the other hand, VLAN-ID=200 is an identifier of a frame corresponding to the VLAN-Y.

The trunk ID is an identifier to identify a trunk that is set in the node device. The port ID is an identifier to identify a port.

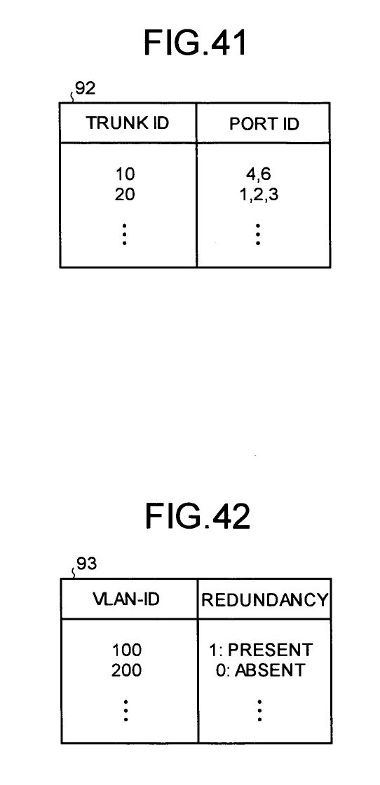

Referring back to FIG. 39, a switch pair table 92 expresses which lines (ports) constitute a trunk. Specifically, as shown in FIG. 41, the switch pair table 92 expresses a relationship between the trunk ID and the port ID (line). The trunk ID is an identifier to identify a trunk that is set in the node device. The port ID is an identifier to identify a port corresponding to plural lines that constitute the trunk.

Referring back to FIG. 39, a redundancy table 93 is used to manage whether a VLAN has redundancy. Specifically, as shown in FIG. 42, the redundancy table 93 has fields of VLAN-ID and redundancy. The VLAN-ID is an identifier to identify a frame corresponding to the VLAN-X or the VLAN-Y, and corresponds to the VLAN-ID shown in FIG. 40. The redundancy expresses whether a VLAN has redundancy.

In the above configuration, in order to secure redundancy in the VLAN-X shown in FIG. 38, regarding the route L1 of the active line, the active line in both directions is set in the order of the node device Edge#1, the node device SW#1, the node device SW#3, and the node device Edge#2, by using a structure explained in the seventh embodiment.

In the VLAN-X, when a frame is transmitted from the terminal X1 to the terminal X2, the reception processing unit Rx1 (the reception processing unit 90: see FIG. 39) of the node device Edge#1 receives this frame. The transfer information extracting unit 21 shown in FIG. 39 extracts the transfer information (in this case, the destination MAC address corresponding to the terminal X2) that expresses the transfer destination and the VLAN-ID (in this case, 100) from the header of the received frame, and outputs the transfer information and the VLAN-ID to a transfer port determining unit 94 and the transfer/copy information adding unit 25.

The transfer port determining unit 94 searches the transfer information table 91 shown in FIG. 40, using the transfer information (the MAC address) and the VLAN-ID (=100) from the transfer information extracting unit 21 as a key, thereby obtaining the information of the output trunk (in this case, the trunk T1).

The transfer port determining unit 94 searches the switch pair table 92 (see FIG. 41) using the output trunk (in this case, the trunk T1) as a key, and obtains information of the output destination port (line). The transport determining unit 94 checks the redundancy (in this case, 1: present) shown in FIG. 42 using the VLAN-ID as a key.

The transfer port determining unit 94 transfers the information of the output destination port (line) corresponding to the port P3 and the port P4 and the result of the check (there is redundancy) to the transfer/copy information adding unit 25.

The transfer/copy information adding unit 25 adds tags corresponding to the port P3 and the port P4 to the frames from the transfer information extracting unit 21, and outputs the frames to the switch S.

The switch S refers to the tags, copies the frames, and transfers the frames to the port P3 (the transmission processing unit Tx3) and the port P4 (the transmission processing unit Tx4) of the node device Edge#1.

Thereafter, in a similar manner to that of the above operation, the terminal X2 receives the frames of the VLAN-X via the route L1 of the active line. When a failure occurs, redundancy is taken in a similar manner to that according to the first embodiment, thereby switching the active line to the backup line.

In the VLAN-Y, when a frame is transmitted from the terminal Y1 to the terminal Y2, the reception processing unit Rx2 (the reception processing unit 90: see FIG. 39) of the node device Edge#1 receives this frame. The transfer information extracting unit 21 shown in FIG. 39 extracts the transfer information (in this case, the destination MAC address corresponding to the terminal Y2) that expresses the transfer destination and the VLAN-ID (in this case, 200) from the header of the received frame, and outputs the transfer information and the VLAN-ID to a transfer port determining unit 94 and the transfer/copy information adding unit 25.

The transfer port determining unit 94 searches the transfer information table 91 shown in FIG. 40, using the transfer information (the MAC address) and the VLAN-ID (=200) from the transfer information extracting unit 21 as a key, thereby obtaining the information of the output port (in this case, the port P3).

The transfer port determining unit 94 checks the redundancy (in this case 0: absent) shown in FIG. 42 using the VLAN-ID as a key. The transfer port determining unit 94 transfers the information of the output port (in this case, the port P3) and the result of the check (there is no redundancy) to the transfer/copy information adding unit 25.

The transfer/copy information adding unit 25 adds the tag corresponding to the port P3 to the frames from the transfer information extracting unit 21, and outputs the frame to the switch S.

The switch S refers to the tag, and transfers the frame to only the port P3 (the transmission processing unit Tx3) of the node device Edge#1. In other words, in the case of the frame of the VLAN-Y, the frame is transferred to only the active line, and the frame is not transferred to the standby frame.

Thereafter, in a similar manner to that of the above operation, the terminal Y2 receives the frame of the VLAN-Y via the route L2. When a failure occurs, the communication between the terminal Y1 and the terminal Y2 is disconnected, because of no redundancy.

As explained above, according to the eighth embodiment, a frame that receives a redundancy service and a frame that does not receive a redundancy service are provided in the same communication network system. With this arrangement, regarding the traffic that requires high reliability, the copying of the frame can provide a redundancy service that makes it possible to execute communication even when a failure occurs, although the copying consumes the resource of the communication network system.

On the other hand, regarding the traffic that does not require high reliability, the use of the network band can be minimized without copying the frame. Therefore, a communication network that satisfies various requirements can be realized.

According to the first embodiment, an example of a configuration that realizes redundancy of a node (a node device) is explained by providing trunks (the trunk T1, the trunk T1A, etc.) to each node. It is also possible to provide redundancy in a link (line) that connects between the nodes, in addition to the node redundancy. An example of this configuration is explained below as a ninth embodiment of the present invention.

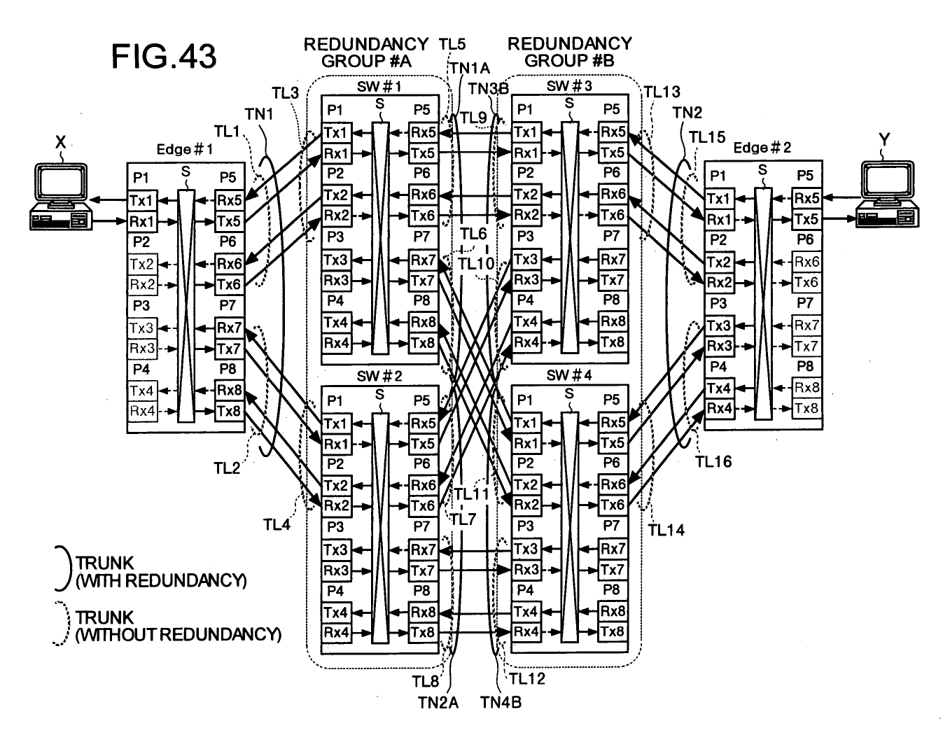

FIG. 43 is a block diagram of a configuration of a node-redundancy control apparatus according to the ninth embodiment. In FIG. 43, a communication network system is shown that includes the two node devices Edge#1 and Edge#2, and the four node devices SW#1 to SW#4, thereby executing communication between the terminal X and the terminal Y.

The terminal X and the terminal Y are computer terminals having a communication function, and execute communication via the communication network system following a predetermined communication protocol. The node device Edge#1 and the node device Edge#2 have a function as edge nodes, and are connected to the terminal X and the terminal Y respectively.

On the other hand, the node devices SW#1 to SW#4 are provided between the node device Edge#1 and the node device Edge#2, and have a function as core nodes. In the node devices SW#1 to SW#4, the node device SW#1 and the node device SW#2 constitute a redundancy group #A, and the node switch SW#3 and the node device SW#4 constitute a redundancy group #B. In the ninth embodiment, a redundancy group can include three or more node devices.

Each of the node device Edge#1, the node device Edge#2, and the node device SW#1 to the node device SW#4 has ports P1 to P8, the switch S, and a switch control unit (not shown).

The port P1 has the transmission processing unit Tx1 and the reception processing unit Rx1. The port P2 has the transmission processing unit Tx2 and the reception processing unit Rx2. The port P3 has the transmission processing unit Tx3 and the reception processing unit Rx3. The port P4 has the transmission processing unit Tx4 and the reception processing unit Rx4.

The port P5 has a transmission processing unit Tx5 and a reception processing unit Rx5. The port P6 has a transmission processing unit Tx6 and a reception processing unit Rx6. The port P7 has a transmission processing unit Tx7 and a reception processing unit Rx7. The port P8 has a transmission processing unit Tx8 and a reception processing unit Rx8.

The port P1 of the node device Edge#1 is connected to the terminal X via a line. In the node device Edge#1, the port P5 is connected to the port P1 of the node device SW#1 via a line, and the port P6 is connected to the port P2 of the node device SW#1 via a line.

In the node device Edge#1, the port P7 is connected to the port P1 of the node device SW#2 via a line, and the port P8 is connected to the port P2 of the node device SW#2 via a line.

In the node device Edge#1, four physical lines (the line of the port P5, the line of the port P6, the line of the port P7, and the line of the port P8) are recognized as one logical line as a node trunk (line) TN1. This node trunk TN1 achieves node redundancy.

In the node trunk TN1, a link between the node device Edge#1 and the node device SW#1 has a redundant configuration (the line of the port P5 and the line of the port P6). The line of the port P5 and the line of the port P6 are recognized as a link trunk TL1. This link trunk TL1 achieves link redundancy.

On the other hand, in the opposite node device SW#1, a link between the node device SW#1 and the node device Edge#1 has a redundant configuration (the line of the port P1 and the line of the port P2). The line of the port P1 and the line of the port P2 are recognized as a link trunk TL3. This link trunk TL3 achieves link redundancy.

Similarly, in the node trunk TN1, a link between the node device Edge#1 and the node device SW#2 has a redundant configuration (the line of the port P7 and the line of the port P8). The line of the port P7 and the line of the port P8 are recognized as a link trunk TL2. This link trunk TL2 achieves link redundancy.

On the other hand, in the opposite node device SW#2, a link between the node device SW#2 and the node device Edge#1 has a redundant configuration (the line of the port P1 and the line of the port P2). The line of the port P1 and the line of the port P2 are recognized as a link trunk TL4. This link trunk TL4 achieves link redundancy.

Regarding the connection between the redundancy group #A and the redundancy group #B, the two node devices that constitute each redundancy group are connected to each other.

Specifically, in the node device SW#1, the port P5 is connected to the port P1 of the node device SW#3 via the line, and the port P6 is connected to the port P2 of the node device SW#3 via the line.

Furthermore, in the node device SW#1, the port P7 is connected to the port P1 of the node device SW#4 via the line, and the port P8 is connected to the port P2 of the node device SW#4 via the line.

In the node device SW#1, four physical lines (the line of the port P5, the line of the port P6, the line of the port P7, and the line of the port P8) are recognized as one logical line as a node trunk (line) TN1A. This node trunk TN1A achieves node redundancy.

In the node trunk TN1A, a link between the node device SW#1 and the node device SW#3 has a redundant configuration (the line of the port P5 and the line of the port P6). The line of the port P5 and the line of the port P6 are recognized as a link trunk TL5. This link trunk TL5 achieves link redundancy.

On the other hand, in the opposite node device SW#3, a link between the node device SW#3 and the node device SW#1 has a redundant configuration (the line of the port P1 and the line of the port P2). The line of the port P1 and the line of the port P2 are recognized as a link trunk TL9. This link trunk TL9 achieves link redundancy.

Similarly, in the node trunk TN1A, a link between the node device SW#1 and the node device SW#4 has a redundant configuration (the line of the port P7 and the line of the port P8). The line of the port P7 and the line of the port P8 are recognized as a link trunk TL6. This link trunk TL6 achieves link redundancy.

On the other hand, in the opposite node device SW#4, a link between the node device SW#4 and the node device SW#1 has a redundant configuration (the line of the port P1 and the line of the port P2). The line of the port P1 and the line of the port P2 are recognized as a link trunk TL11. This link trunk TL11 achieves link redundancy.

In the node device SW#2, the port P5 is connected to the port P3 of the node device SW#3 via the line, and the port P6 is connected to the port P4 of the node device SW#3 via the line.

Furthermore, in the node device SW#2, the port P7 is connected to the port P3 of the node device SW#4 via the line, and the port P8 is connected to the port P4 of the node device SW#4 via the line.

In the node device SW#2, four physical lines (the line of the port P5, the line of the port P6, the line of the port P7, and the line of the port P8) are recognized as one logical line as a node trunk (line) TN2A. This node trunk TN2A achieves node redundancy.

In the node trunk TN2A, a link between the node device SW#2 and the node device SW#3 has a redundant configuration (the line of the port P5 and the line of the port P6). The line of the port P5 and the line of the port P6 are recognized as a link trunk TL7. This link trunk TL7 achieves link redundancy.

On the other hand, in the opposite node device SW#3, a link between the node device SW#3 and the node device SW#2 has a redundant configuration (the line of the port P3 and the line of the port P4). The line of the port P3 and the line of the port P4 are recognized as a link trunk TL10. This link trunk TL10 achieves link redundancy.

Similarly, in the node trunk TN2A, a link between the node device SW#2 and the node device SW#4 has a redundant configuration (the line of the port P7 and the line of the port P8). The line of the port P7 and the line of the port P8 are recognized as a link trunk TL8. This link trunk TL8 achieves link redundancy.

On the other hand, in the opposite node device SW#4, a link between the node device SW#4 and the node device SW#2 has a redundant configuration (the line of the port P3 and the line of the port P4). The line of the port P3 and the line of the port P4 are recognized as a link trunk TL12. This link trunk TL12 achieves link redundancy.

In the node device SW#3, the four lines of the ports P1 to P4 are recognized as a node trunk TN3B.

In the node device Edge#2, the port P5 is connected to the terminal Y, and the port P1 is connected to the port P5 of the node device SW#3 via the line. Also, the port P2 is connected to the port P6 of the node device SW#3.

Furthermore, in the node device Edge#2, the port P3 is connected to the port P5 of the node device SW#4 via the line, and the port P4 is connected to the port P6 of the node device SW#4.

In the node device Edge#2, four physical lines (the line of the port P1, the line of the port P2, the line of the port P3, and the line of the port P4) are recognized as one logical line as a node trunk (line) TN2. This node trunk TN2 achieves node redundancy.

In the node trunk TN2, a link between the node device Edge#2 and the node device SW#3 has a redundant configuration (the line of the port P1 and the line of the port P2). The line of the port P1 and the line of the port P2 are recognized as a link trunk TL15. This link trunk TL15 achieves link redundancy.

On the other hand, in the opposite node device SW#3, a link between the node device SW#3 and the node device Edge#2 has a redundant configuration (the line of the port P5 and the line of the port P6). The line of the port P5 and the line of the port P6 are recognized as a link trunk TL13. This link trunk TL13 achieves link redundancy.

Similarly, in the node trunk TN2, a link between the node device Edge#2 and the node device SW#4 has a redundant configuration (the line of the port P3 and the line of the port P4). The line of the port P3 and the line of the port P4 are recognized as a link trunk TL16. This link trunk TL16 achieves link redundancy.

On the other hand, in the opposite node device SW#4, a link between the node device SW#4 and the node device Edge#2 has a redundant configuration (the line of the port P5 and the line of the port P6). The line of the port P5 and the line of the port P6 are recognized as a link trunk TL14. This link trunk TL14 achieves link redundancy.

In the node device SW#4, the four lines of the port P1 to the port P4 are recognized as a node trunk TN4B.

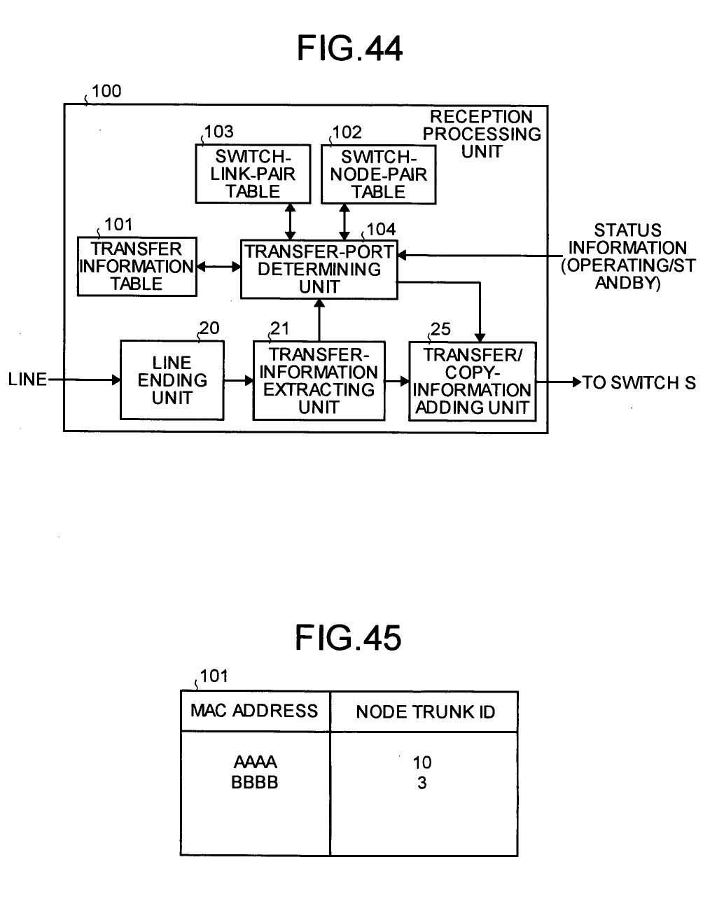

In the ninth embodiment, a reception processing unit 100 shown in FIG. 44 is used for the reception processing units Rx1 to Rx8 shown in FIG. 43. In FIG. 44, like parts corresponding to those in FIG. 4 are designated with like reference signs.

In the reception processing unit 100, a transfer information table 101 expresses a relationship with the MAC address and the node trunk ID (including the port ID) as shown in FIG. 45. The MAC address is transfer information extracted by the transfer information extracting unit 21. The node trunk ID is an identifier to identify a node trunk set in the node device.

When the trunk ID=10 shown in FIG. 45 corresponds to the node trunk TN1A of the node device SW#1 shown in FIG. 43, the frame (corresponding to the MAC address=AAAA) received by the reception processing unit Rx1 of the port P1 is transferred to the node trunk TN1A (the port P5, the port P6, the port P7, and the port P8) of the trunk ID=10, based on the transfer information table 101 (see FIG. 45).

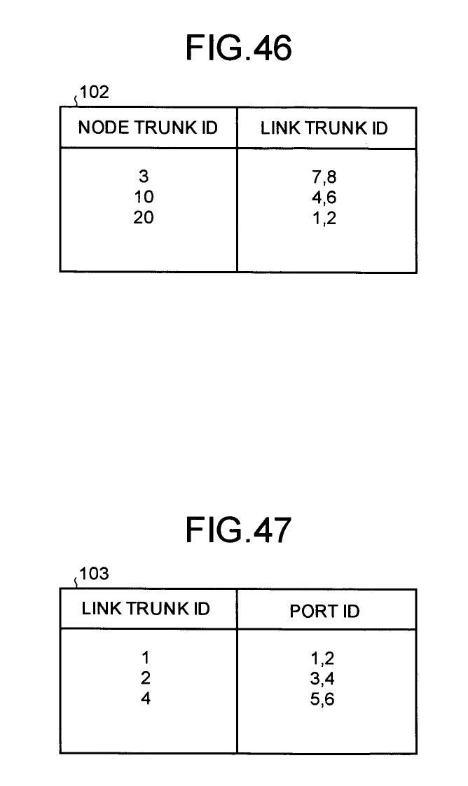

Referring back to FIG. 44, a switch node pair table 102 expresses which link trunk constitutes a node trunk. Specifically, as shown in FIG. 46, the switch node pair table 102 expresses a relationship between the node trunk ID and the link trunk ID. The node trunk ID is an identifier to identify a node trunk that is set in the node device. The link trunk ID is an identifier to identify plural link trunks that constitute the node trunk.

When the node trunk ID=10 corresponds to the node trunk TN1A of the node device SW#1 shown in FIG. 43, the link trunk IDs (=4, 6) correspond to the link trunks TL5 and TL6 that constitute the node trunk TN1A.

Referring back to FIG. 44, a switch link pair table 103 expresses which line (port) constitutes a link trunk. Specifically, as shown in FIG. 47, the switch link pair table 103 expresses a relationship between the link trunk ID and the port ID (line). The link trunk ID is an identifier to identify a link trunk that is set in the node device. The port ID is an identifier to identify a port corresponding to plural lines that constitute the trunk.

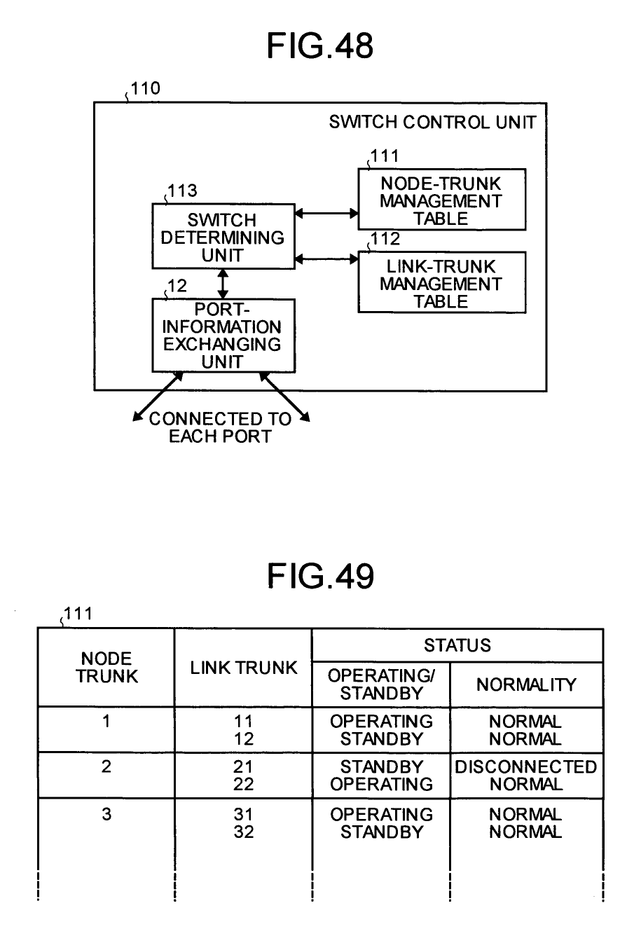

According to the ninth embodiment, a switch control unit 110 shown in FIG. 48 is used in each node device. In FIG. 48, like parts corresponding to those in FIG. 7 are designated with like reference signs.

In the switch control unit 110, a node-trunk management table 111 is used to manage the node trunk of each node device. Specifically, the node-trunk management table 111 expresses a relationship between a node trunk, a link trunk, and a status as shown in FIG. 49.

In FIG. 49, the node trunk expresses a node trunk that is set in each node device. The link trunk expresses a link trunk that is set in each node device. The status expresses operating/standby and normality. The operating/standby expresses whether the link trunk (line) is an active line-or a backup line. The normality expresses whether the link trunk (line) is normal or is disconnected due to the occurrence of a failure.

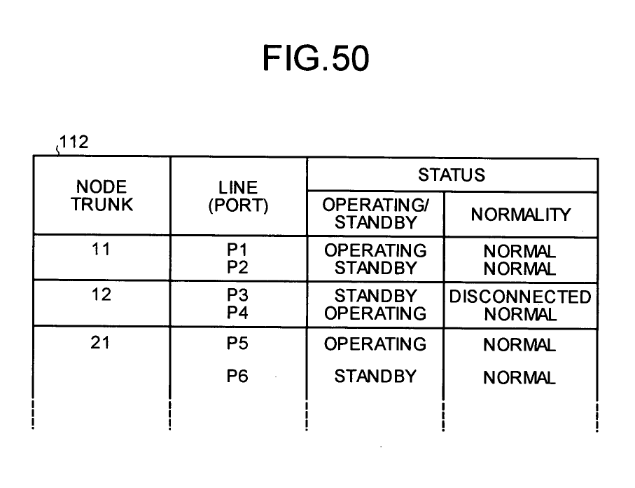

Referring back to FIG. 48, a link-trunk management table 112 is used to manage a link trunk of each node device. Specifically, the link-trunk management table 112 expresses a relationship between a link trunk, a line, and a status as shown in FIG. 50.

In FIG. 50, the link trunk expresses a link trunk that is set in each node device. The line (port) expresses a line (port) that constitutes the link trunk. The status expresses operating/standby and normality. The operating/standby expresses whether the line (port) is an active line or a backup line. The normality expresses whether the line (port) is normal or is disconnected due to the occurrence of a failure.

Referring back to FIG. 48, a switch determining unit 113 determines about a switching based on the node-trunk management table 111 and the link-trunk management table 112.

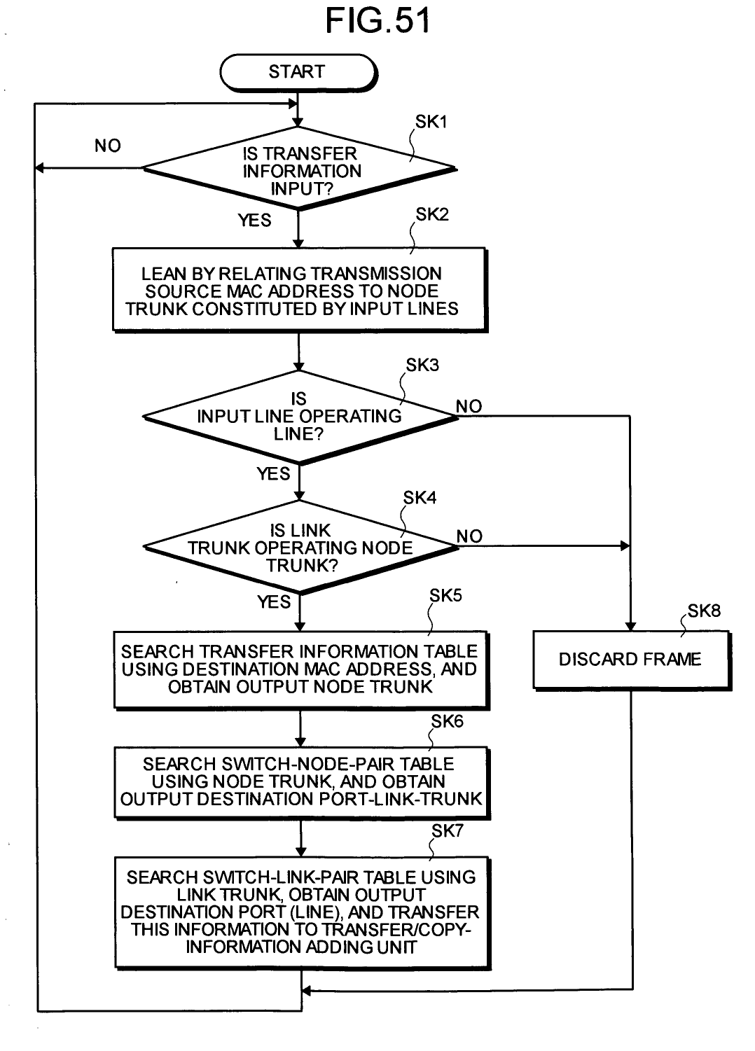

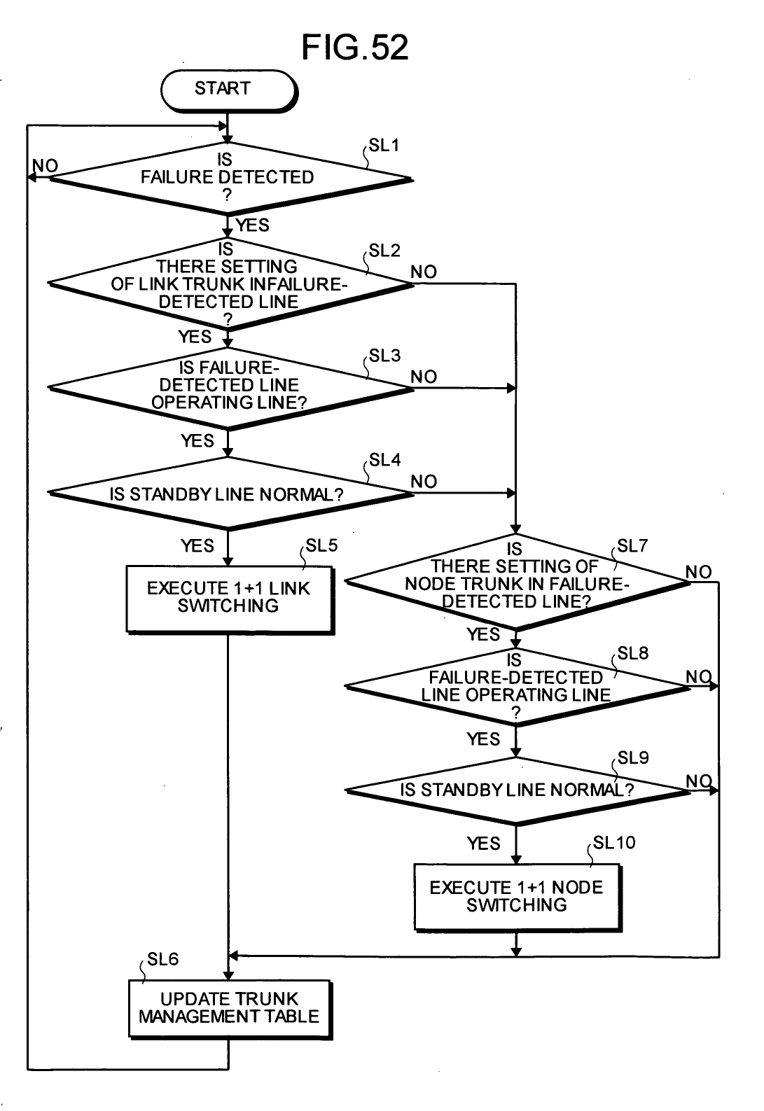

The operation of the node-redundancy control apparatus according to the ninth embodiment is explained next with reference to flowcharts shown in FIGS. 51 and 52. FIG. 51 is a flowchart for explaining the operation of the transfer port determining unit 104 shown in FIG. 44. FIG. 52 is a flowchart for explaining the operation of the switch determining unit 113 shown in FIG. 48.

A transmission of a frame from the terminal X to the terminal Y shown in FIG. 43 is explained below. At step SK1 shown in FIG. 51, the transfer port determining unit 104 (see FIG. 44) of each reception processing unit determines whether transfer information (frame) is input. In this case, the transfer port determining unit 104 sets “No” as the result of the determination made, and repeats the determination.

At step SL1 shown in FIG. 52, the switch determining unit 113 (see FIG. 48) determines whether a failure is detected in the port. In this case, the switch determining unit 113 sets “No” as the result of the determination made, and repeats the determination.

When a frame is transmitted from the terminal X to the terminal Y shown in FIG. 43, the reception processing unit Rx1 (the reception processing unit 100: see FIG. 44) of the node device Edge#1 receives this frame.

In other words, the line terminating unit 20 ends the electrical signal and the optical signal corresponding to the frame. The transfer information extracting unit 21 extracts the transfer information (in this case, a destination MAC address corresponding to the terminal Y) that indicates a transfer destination from the header of the received frame, and outputs the transfer information to the transfer port determining unit 104 and the transfer/copy information adding unit 25.

The transfer port determining unit 104 sets “Yes” as the result of the determination made at step SK1 shown in FIG. 51. At step SK2, the transfer port determining unit 104 leans by relating the transmission source MAC address to the node trunk that constitutes the input line.

At step SK3, the transfer port determining unit 104 determines whether the input line (the line corresponding to the port P1) is an active line of the link trunk based on the status information (in this case, the active line) from the switch control unit 110 (see FIG. 48). In this case, the transfer port determining unit 104 sets “Yes” as the result of the determination made at step SK3, because the port P1 is the active line although the port P1 does not constitute a link trunk.

At step SK4, the transfer port determining unit 104 determines whether the link trunk is an operating node trunk. Because the port P1 is the active line, the transfer port determining unit 194 sets “Yes” as the result of the determination made at step SK4.

At step SK5, the transfer port determining unit 104 searches the transfer information table 101 (see FIG. 45) using the transfer information (the destination MAC address) from the transfer information extracting unit 21 as a key, and obtains information of an output node trunk (in this case, the node trunk TN1).

At step SK6, the transfer port determining unit 104 searches the switch node pair table 102 (see FIG. 46) using the output node trunk (in this case, the trunk node TN1) as a key, and obtains information of the output destination link trunk. In this case, the output destination link trunk is the link trunk TL1 and the link trunk TL2 that constitute the node trunk TN1.

At step SK7, the transfer port determining unit 104 searches the switch link pair table 103 (see FIG. 47) using the output destination link trunk (in this case, the link trunk TL1 and the link trunk TL2) as a key, and obtains information of the output destination port (line).

In this case, the output destination ports are the port P5, the port P6, the port P7, and the port P8 of the node device Edge#1 shown in FIG. 43. The transfer port determining unit 104 transfers the information of the output destination ports (lines) corresponding to the port P5, the port P6, the port P7, and the port P8 to the transfer/copy information adding unit 25, and determines at step SK1.

The transfer/copy information adding unit 25 adds tags corresponding to port P5, the port P6, the port P7, and the port P8 to the frames from the transfer information extracting unit 21, and outputs the frames to the switch S.

The switch S refers to the tags and copies the frames, and transfers each frame to the port P5 (the transmission processing unit Tx5), the port P6 (the transmission processing unit Tx6), the port P7 (the transmission processing unit Tx7), and the port P8 (the transmission processing unit Tx8) of the node device Edge#1 respectively.

In the node device Edge#1, the port P5 (the transmission processing unit Tx5) transmits the frame to the port P1 (the reception processing unit Rx1) of the node device SW#1, and the port P6 (the transmission processing unit Tx6) transmits the frame to the port P2 (the reception processing unit Rx2) of the node device SW#1.

Similarly, in the node device Edge#1, the port P7 (the transmission processing unit Tx7) transmits the frame to the port P1 (the reception processing unit Rx1) of the node device SW#2, and the port P8 (the transmission processing unit Tx8) transmits the frame to the port P2 (the reception processing unit Rx2) of the node device SW#2.

When the port P1 (the reception processing unit Rx1) of the node device SW#1 receives the frame, the transfer port determining unit 104 of the reception processing unit Rx1 sets “Yes” as the result of the determination made at step SK1 shown in FIG. 51. At step SK2, the transfer port determining unit 104 leans by relating the transmission source MAC address to the node trunk that constitutes the input line.

At step SK3, the transfer port determining unit 104 determines whether the input line (the line corresponding to the port P1) is an active line of the link trunk based on the status information (in this case, the active line) from the switch control unit 110 (see FIG. 48).

In this case, the transfer port determining unit 104 sets “Yes” as the result of the determination made at step SK3, because the input line (the line corresponding to he port P1) is the active line. Thereafter, through the above operation, the switch S copies the frames, and are transmitted from the node trunk TN1A (the port P5, the port P6, the port P7, and the port P8).

On the other hand, when the port P2 (the reception processing unit Rx2) of the node device SW#1 receives the frame, the transfer port determining unit 104 of the reception processing unit Rx2 sets “Yes” as the result of the determination made at step SK1 shown in FIG. 51. At step SK2, the transfer port determining unit 104 leans by relating the transmission source MAC address to the node trunk that constitutes the input line.

At step SK3, the transfer port determining unit 104 determines whether the input line (the line corresponding to the port P2) is an active line of the link trunk based on the status information (in this case, the backup line) from the switch control unit 110 (see FIG. 48). In this case, the transfer port determining unit 104 sets “No” as the result of the determination made. At step SK8, the transfer port determining unit 104 discards the received frame.

When the link trunk is a standby node trunk, the transfer port determining unit 104 sets “No” as the result of the determination made at step SK4, and the frame is discarded at step SK8. Thereafter, each node device executes the above operation, and the terminal Y receives the frame.

The above explains the operation carried out when the network is normally operating. The operation when a failure (a node failure) occurs in the node device itself that constitutes a redundancy group is explained next.

When the node failure occurs, the switch determining unit 113 (see FIG. 48) of the reception processing unit of the node device connected, via the line, to the node device in which the failure occurs sets “Yes” as the result of the determination made at step SL1 shown in FIG. 52.

At step SL2, the switch determining unit 113 refers to the link-trunk management table 112 (see FIG. 50), and determines whether there is a setting of a link trunk in the failure-detected line. When a result of the determination made is “Yes”, the switch determining unit 113 refers to the link-trunk management table 112, and determines whether the failure-detected line is the active line, at step SL3.

When a result of the determination made at step SL3 is “Yes”, the switch determining unit 113 determines, at step SL4, whether the backup line is normal. When a result of the determination made at step SL4 is “Yes”, the switch determining unit 113 executes, at step SL5, the 1+1 link switching to switch the active line (link) from the failure-detected line (link) to the backup line (link).

At step SL6, the switch determining unit 113 updates the node-trunk management table 111 and the link-trunk management table 112.

On the other hand, when a result of the determination made at step SL2, the step SL3, or the step SL4 is “No”, the switch determining unit 113 refers to the node management table 111 (see FIG. 49), and determines whether there is a setting of a node trunk in the failure-detected line (link trunk), at step SL7. When a result of the determination made is “Yes”, the switch determining unit 113 refers to the node-trunk management table 111, and determines whether the failure-detected line (link trunk) is the active line, at step SL8.

When a result of the determination made at step SL8 is “Yes”, the switch determining unit 113 determines, at step SL9, whether the failure-detected line (the link trunk) is normal. When a result of the determination made at step SL9 is “Yes”, the switch determining unit 113 executes, at step SL10, the 1+1 link switching to switch the active line (link trunk) from the failure-detected line (link trunk) to the backup line (link trunk).

At step SL6, the switch determining unit 113 updates the node-trunk management table 111 and the link-trunk management table 112.

As explained above, according to the ninth embodiment, plural active lines and plural backup lines are provided based on link information, thereby providing a redundant configuration. Therefore, reliability of the communication network system can be increased.

According to the ninth embodiment, the following configuration can be provided. A frame is transmitted via one normal active line out of plural lines (for example, the link trunk TL1 in FIG. 43) of the node trunk TN1. At the same time, a frame is transmitted via one normal backup line out of plural backup lines (for example, the link trunk TL2) in a redundant configuration. Based on this configuration, traffic can be decreased. An example of this configuration is explained below as a tenth embodiment of the present invention.

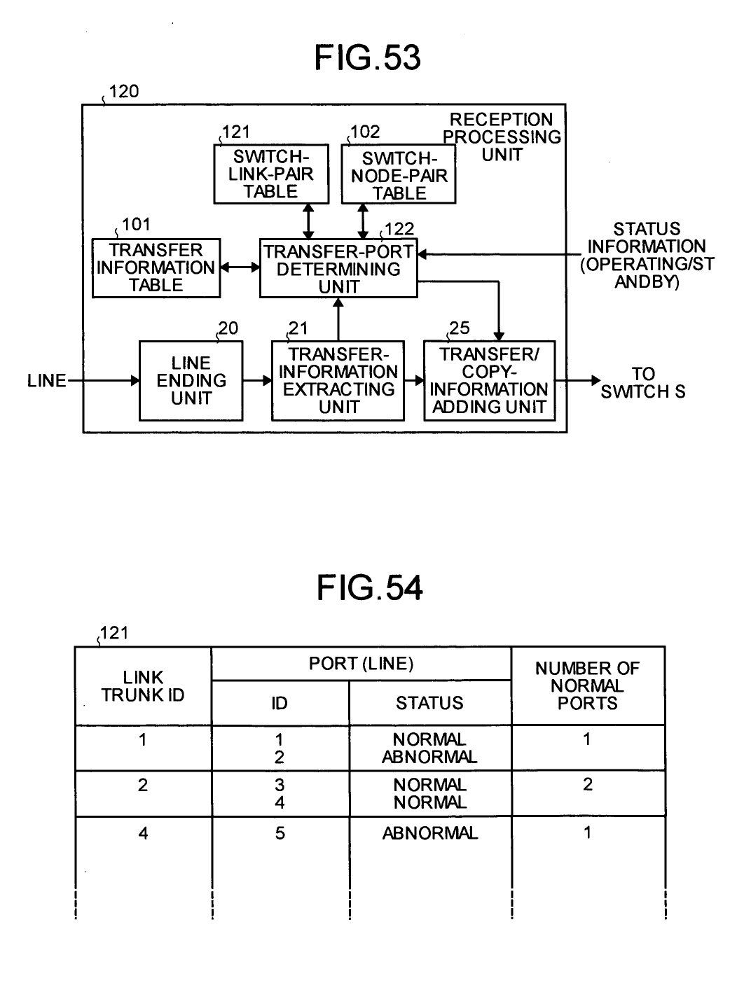

FIG. 43 is a block diagram of the configuration of a node-redundancy control apparatus according to the tenth embodiment. For the reception processing units Rx1 to Rx8 shown in FIG. 43, a reception processing unit 120 shown in FIG. 53 is used in place of the reception processing unit 100 shown in FIG. 44. In FIG. 53, like parts corresponding to those in FIG. 44 are designated with like reference signs.

In the reception processing unit 120, the switch link pair table 121 expresses a relationship between a link trunk ID, a port ID (line), and a number of normal ports, as shown in FIG. 54. The link trunk ID is an identifier to identify a link trunk that is set in the node device.

In the port (line), the ID is an identifier to identify a port corresponding to plural lines that constitute the trunk. The status expresses a status (normal or abnormal) of the port (line). The number of normal ports is a number of normal ports (lines) in the link trunk. Referring back to FIG. 53, the transfer port determining unit 122 has a function of determining a transfer port.

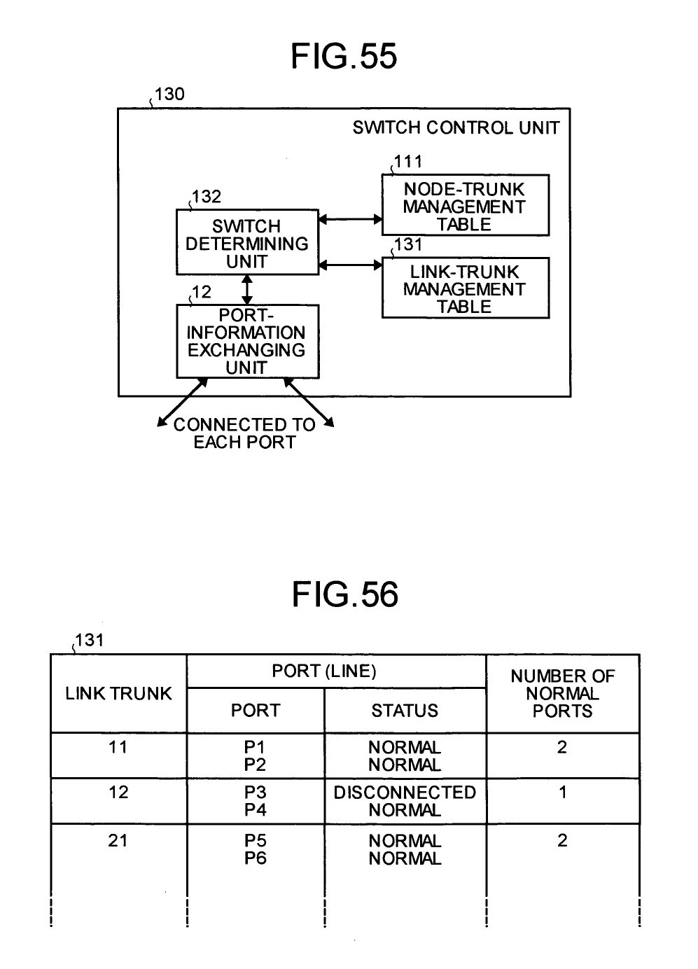

According to the tenth embodiment, a switch control unit 130 shown in FIG. 55 is used in place of the switch control unit 110 shown in FIG. 48. In FIG. 55, like parts corresponding to those in FIG. 48 are designated with like reference signs.

In the switch control unit 130, a link-trunk management table 131 is used to manage a link trunk of each node device. Specifically, the link-trunk management table 131 expresses a relationship between a link trunk, a port (line), and a number of normal ports as shown in FIG. 56. The link trunk is an identifier to identify a link trunk that is set in the node device.

In the port (line), a port expresses a port corresponding to plural lines that constitute the link trunk. The status expresses a status (normal or disconnected) of the port (line). The number of normal ports expresses a number of normal ports (lines) in the link trunk. Referring back to FIG. 55, a switch determining unit 132 determines about a switching based on the node-trunk management table 111 and the link-trunk management table 131.

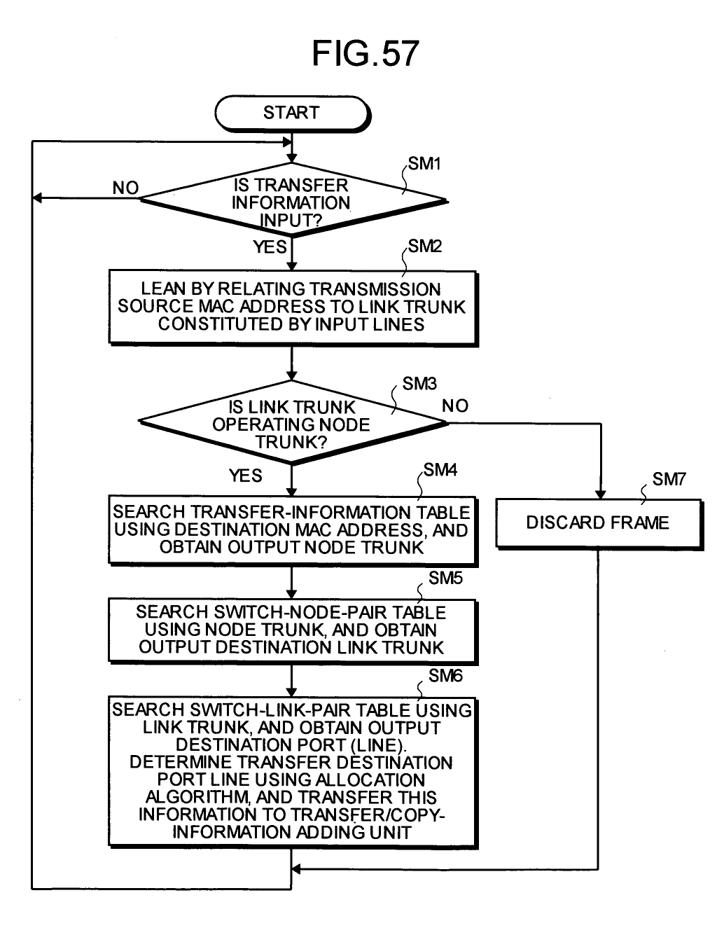

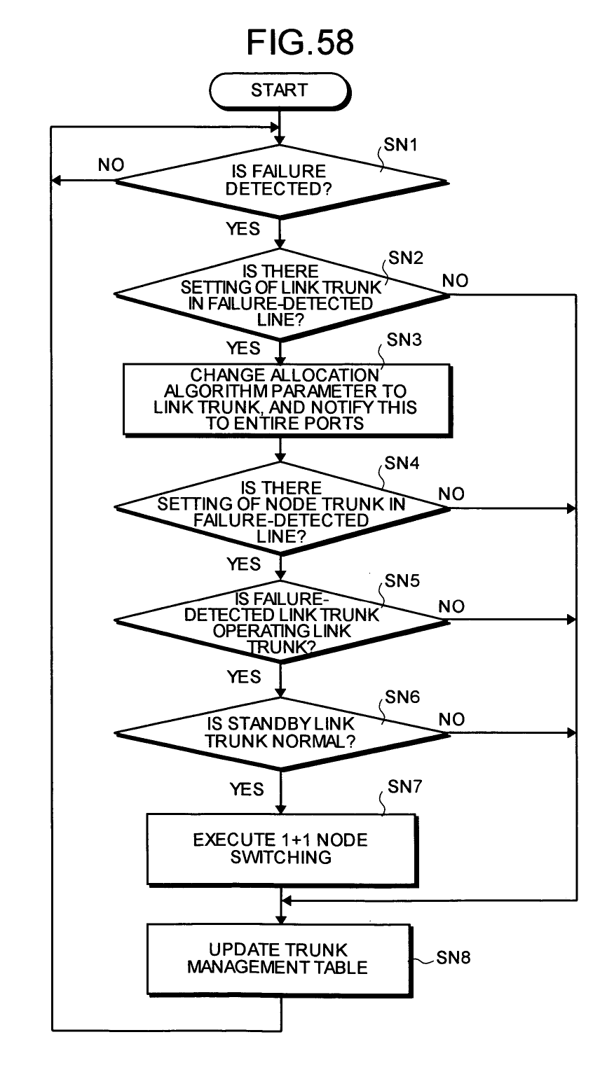

The operation of the node-redundancy control apparatus according to the tenth embodiment is explained next with reference to flowcharts shown in FIGS. 57 and 58. FIG. 57 is a flowchart for explaining the operation of the transfer port determining unit 122 shown in FIG. 53. FIG. 58 is a flowchart for explaining the operation of the switch determining unit 132 shown in FIG. 44.

At step SM1 shown in FIG. 57, the transfer port determining unit 122 (see FIG. 53) of each reception processing unit determines whether transfer information (frame) is input. In this case, the transfer port determining unit 122 sets “No” as the result of the determination made, and repeats the determination.

When a result of the determination made at step SM1 is “Yes”, the transfer port determining unit 122, at step SM2, leans by relating the transmission source MAC address to the link trunk that constitutes the input line.

At step SM3, the transfer port determining unit 122 determines whether the link trunk is an operating node trunk. When the port P1 is the active line, the transfer port determining unit 122 sets “Yes” as the result of the determination made at step SM3.

At step SM4, the transfer port determining unit 122 searches the transfer information table 101 (see FIG. 45) using the transfer information (the destination MAC address) from the transfer information extracting unit 21 as a key, and obtains information of an output node trunk.

At step SM5, the transfer port determining unit 122 searches the switch node pair table 102 (see FIG. 46) using the output node trunk as a key, and obtains information of the output destination link trunk.

At step SM6, the transfer port determining unit 122 searches the switch link pair table 121 (see FIG. 54) using the output destination link trunk as a key, and obtains information of the output destination port (line).

The transfer port determining unit 122 then determines one normal port (line) out of plural output destination ports (lines), adds tags corresponding to frames from the transfer information extracting unit 21, and outputs the frames to the switch S. The switch S refers to the tags and transfers each frame to one port respectively. When a result of the determination made at step SM3 is “No”, the frames are discarded at step SM7.

The above explains the operation carried out when the network is normally operating. The operation when a failure (a node failure) occurs in the node device itself that constitutes a redundancy group is explained next.

At step SN1 shown in FIG. 58, the switch determining unit 132 of the switch control unit 130 of each node device determines whether a failure is detected. In this case, the switch determining unit 132 sets “No” as the result of the determination made, and repeats the determination.

When a node failure occurs, the switch determining unit 132 of the reception processing unit of the node device, connected via the line to the node device in which the failure occurs, sets “Yes” as the result of the determination made at step SN1 shown in FIG. 58.

At step SN2, the switch determining unit 132 determines whether there is a setting of a link trunk in the failure-detected line. When a result of the determination made is “Yes”, the switch determining unit 132 changes an allocation algorithm parameter to the link trunk, and notifies this to all ports.

At step SN4, the switch determining unit 132 determines whether there is a setting of a node trunk in the failure-detected line. In this case, the switch determining unit 132 sets “Yes” as the result of the determination made. At step SN5, the switch determining unit 132 determines whether the failure-detected line is the active line.

When a result of the determination made at step SN5 is “Yes”, the switch determining unit 132 determines, at step SN6, whether the backup line is normal. When a result of the determination made at step SN6 is “Yes”, the switch determining unit 132 executes, at step SN7, the 1+1 link switching to switch the active line (node) from the failure-detected line (node) to the backup line (node).

At step SN8, the switch determining unit 132 updates the node-trunk management table 111 and the link-trunk management table 131.

On the other hand, when a result of the determination made at step SN2, the step SN4, the step SN5, or the step SN6 is “No”, the switch determining unit 132 executes the above processing.

As explained above, according to the tenth embodiment, information is transmitted via one normal active line out of plural active lines in a redundant configuration. At the same time, a frame is transmitted via one normal backup line out of plural backup lines in a redundant configuration. Therefore, traffic can be decreased more than that according to the ninth embodiment.

According to the fourth embodiment, plural VLANs can be configured on the communication network system. An example of this configuration is explained below as an eleventh embodiment of the present invention.

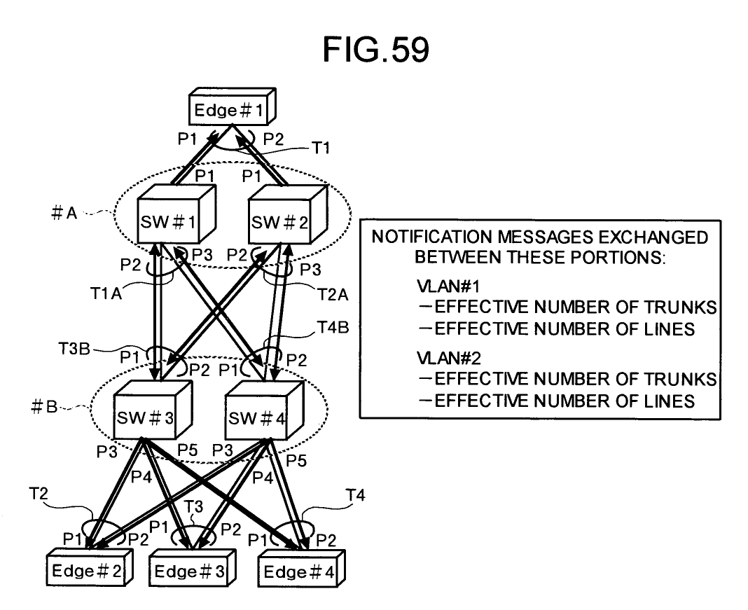

FIG. 59 is a block diagram of a configuration of a node-redundancy control apparatus for explaining the operation according to the eleventh embodiment. In FIG. 59, like parts corresponding to those in FIG. 21 are designated with like reference signs. In the eleventh embodiment, plural VLANs (for example, a VLAN#1 and a VLAN#2) are configured in the communication network system shown in FIG. 59.

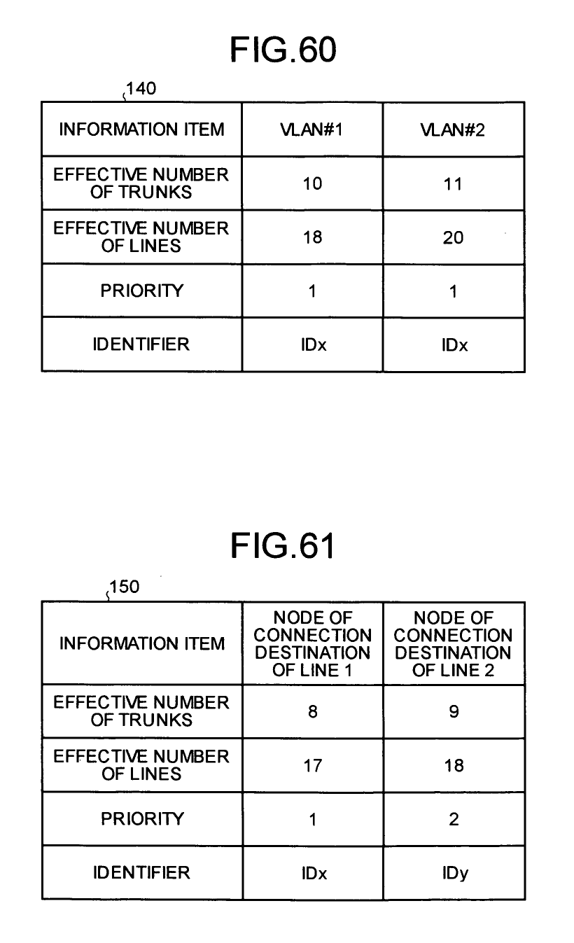

According to the eleventh embodiment, in the switch control device of each node device, a counter node management table 150 shown in FIG. 61 is used in place of the counter node management table 61 shown in FIG. 25A. At the same time, a self node management table 140 shown in FIG. 60 is used in place of the self node management table 62 shown in FIG. 25B.

The counter node management table 150 shown in FIG. 61 contains information similar to that in the counter node management table 61 (see FIG. 25A), and is set in a trunk unit and in a VLAN unit (for example, the VLAN#1 and the VLAN#2).

The self node management table 140 shown in FIG. 60 is used to manage information of an effective number of trunks, an effective number of lines, priority, and an identifier concerning the self node that are set for each VLAN.

According to the eleventh embodiment, the operation explained in the fourth embodiment is executed for each VLAN.

As explained above, according to the eleventh embodiment, the traffic load at the time of switching due to the node failure can be decreased, and the line can be switched at a high speed.

While the first to the eleventh embodiments of the present invention are explained above in detail with reference to the drawings, detailed configurations are not limited to those according to the first to the eleventh embodiments, and any design modification without departing from the scope of the present invention is included in the invention.

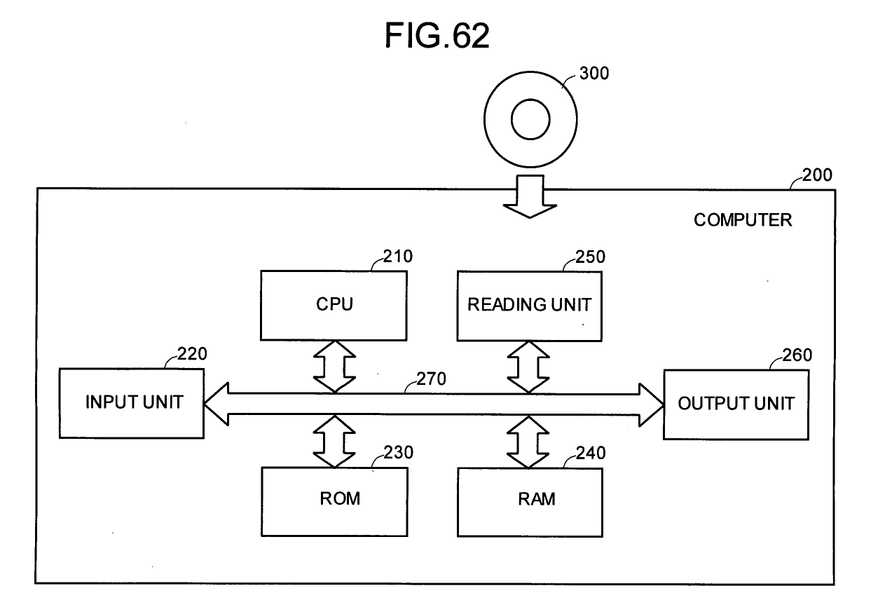

For example, in the first to the eleventh embodiments, a program for achieving the function (the node redundancy control) of each node device can be recorded on a computer-readable recording medium 300 shown in FIG. 62. A computer 200 shown in FIG. 62 can read the program recorded on the recording medium 300, and execute the program, thereby achieving each function.

The computer 200 shown in FIG. 62 includes a central processing unit (CPU) 210 that executes the program, an input unit 220 such as a keyboard and a mouse, a read only memory (ROM) 230 that stores various kinds of data, a random access memory (RAM) 240 that stores operation parameters, a reading unit 250 that reads the program from the recording medium 300, an output unit 260 such as a display and a printer, and a bus 270 for connecting between various parts of the device.

The CPU 210 reads the program recorded on the recording medium 300 via the reading unit 250, and executes the program, thereby achieving the functions. The recording medium 300 includes an optical disk, a flexible disk, and a hard disk.

As explained above, according to the present invention, the same information is received via the active line and the backup line(s). The information received via the backup line(s) is discarded. The information received via the active line is transmitted to the next node. When a failure occurs, the active line is switched to the backup line. Therefore, there is an effect that the traffic load at the switching time due to the node failure can be decreased, and the line can be switched in a very short period.

Furthermore, according to the present invention, when a failure occurs, the occurrence of the failure is notified to a node of the connection destination that is under the influence of the failure. Therefore, there is an effect that the traffic load at the switching time due to the node failure can be decreased, and the line can be switched at a high speed.

Moreover, according to the present invention, nodes within the group notify their communication capacities to each other. When a failure occurs, a node having the highest communication capacity among the plural nodes within the group executes communication. Therefore, there is an effect that communication can be carried out using a node having a higher communication capacity.

Furthermore, according to the present invention, a node notifies the own communication capacity to other plural counter nodes. When a failure occurs, a node having the highest communication capacity among the plural counter nodes executes communication. Therefore, there is an effect that communication can be carried out using a node having a higher communication capacity.

Moreover, according to the present invention, based on a command input, the active line is forcibly switched to the backup line. Therefore, there is an effect that convenience for the manager can be increased.

According to the present invention, based on a command input, the active line of other node is forcibly switched to the backup line by remote control. Therefore, there is an effect that convenience for the manager can be increased.

Furthermore, according to the present invention, based on a command input, the active line of the self node is locally and forcibly switched to the backup line. Therefore, there is an effect that convenience for the manager can be increased.

Moreover, according to the present invention, both a first communication system having redundancy of an active line and a backup line and a second communication system using only an active line without redundancy are employed. Therefore, the first communication system is used for the traffic that requires high reliability, and the second communication system is used for the traffic that does not require high reliability. With this arrangement, there is an effect that the use of a network band can be minimized, and that a communication network system capable of satisfying various requirements can be provided.

Furthermore, according to the present invention, plural active lines and plural backup lines are provided as a redundant configuration. Therefore, reliability of the network system can be increased.

Moreover, according to the present invention, information is transmitted via one normal active line out of plural active lines in a redundant configuration. At the same time, a frame is transmitted via one normal backup line out of plural backup lines in a redundant configuration. Therefore, there is an effect that traffic can be decreased.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A node-redundancy control method for a network system including a node located at each edge of the network and a group of a plurality of nodes, the node-redundancy control method comprising:
first transmitting including copying information received from the node; and
transmitting the information to each of the nodes of a next-stage group via an active line and at least one backup line;
receiving including receiving the information via the active line and the backup line; and
discarding the information received via the backup line;
second transmitting including transmitting the information received via the active line to a nodes of a next-stage group; and
switching, when a failure occurs, the active line to the backup line.

2. The node-redundancy control method according to claim 1, further comprising notifying an occurrence of the failure to a node of a connection destination that is affected by the failure.

3. The node-redundancy control method according to claim 1, further comprising:
notifying a communication capacity between the nodes within the group; and
making, when the failure occurs, a node having a high communication capacity execute a communication from among the nodes within the group.

4. The node-redundancy control method according to claim 1, further comprising:
notifying a communication capacity of a local node to a plurality of counter nodes; and
making, when a failure occurs, a node having a high communication capacity execute a communication from among the counter nodes.

5. The node-redundancy control method according to claim 1, further comprising switching forcibly the active line to the backup line based on a command input.

6. The node-redundancy control method according to claim 5, wherein the switching forcibly includes switching forcibly the active line of other node to the backup line by remote control based on the command input.

7. The node-redundancy control method according to claim 5, wherein the switching forcibly includes switching forcibly and locally the active line of a local node to the backup line based on the command input.

8. The node-redundancy control method according to claim 1, wherein the network system includes
a first communication system having a redundancy based on the active line and the backup line; and
a second communication system having only the active line without a redundancy.

9. The node-redundancy control method according to claim 1, wherein a plurality of the active lines and a plurality of the backup lines are provided in a redundant manner.

10. The node-redundancy control method according to claim 9, wherein the first transmitting further includes transmitting the information via one normal active line from among the active lines provided in the redundant manner and one normal backup line from among the backup lines provided in the redundant manner.

11. The node-redundancy control method according to claim 1, wherein
a plurality of virtual local-area-networks are built in the network system, and
the switching includes switching, when the failure occurs, the active line to the backup line for each of the virtual local-area-networks.

12. A node-redundancy control apparatus for a network system including a node located at each edge of the network and a group of a plurality of nodes, the node-redundancy control apparatus comprising:
a first transmitting unit that copies information received from the node, and transmits the information to each of the nodes of a next-stage group via an active line and at least one backup line;
a receiving unit that receives the information via the active line and the backup line, and discards the information received via the backup line;
a second transmitting unit that transmits the information received via the active line to a node of a next-stage group; and
a switching unit that switches, when a failure occurs, the active line to the backup line.

13. The node-redundancy control apparatus according to claim 12, further comprising a failure notifying unit that notifies an occurrence of the failure to a node of a connection destination that is affected by the failure.

14. The node-redundancy control apparatus according to claim 12, further comprising:
a notifying unit that notifies a communication capacity between the nodes within the group; and
a communication arranging unit that makes, when the failure occurs, a node having a high communication capacity execute a communication from among the nodes within the group.

15. The node-redundancy control apparatus according to claim 12, further comprising:
a notifying unit that notifies a communication capacity of a local node to a plurality of counter nodes; and
a communication arranging unit that makes, when a failure occurs, a node having a high communication capacity execute a communication from among the counter nodes.

16. The node-redundancy control apparatus according to claim 12, further comprising a forcible switching unit that forcibly switches the active line to the backup line based on a command input.

17. The node-redundancy control apparatus according to claim 16, wherein the forcible switching unit forcibly switches the active line of other node to the backup line by remote control based on the command input.

18. The node-redundancy control apparatus according to claim 16, wherein the forcible switching unit forcibly and locally switches the active line of a local node to the backup line based on the command input.

19. The node-redundancy control apparatus according to claim 12, wherein the network system includes
a first communication system having a redundancy based on the active line and the backup line; and
a second communication system having only the active line without a redundancy.

20. The node-redundancy control apparatus according to claim 12, wherein a plurality of the active lines and a plurality of the backup lines are provided in a redundant manner.

21. The node-redundancy control apparatus according to claim 20, wherein the first transmitting unit transmits the information via one normal active line from among the active lines provided in the redundant manner and one normal backup line from among the backup lines provided in the redundant manner.

22. The node-redundancy control apparatus according to claim 12, wherein
a plurality of virtual local-area-networks are built in the network system, and
the switching unit switches, when the failure occurs, the active line to the backup line for each of the virtual local-area-networks.
